(19) United States
(12) Patent Application Publication
(10) Pub. No.: US 2025/0212203 A1
(43) Pub. Date: Jun. 26, 2025

(54) BEAM OPERATION FOR SINGLE-TRP OR UPLINK MULTI-TRP

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/981,110

(22) Filed: Dec. 13, 2024

Related U.S. Application Data
(60) Provisional application No. 63/614,793, filed on Dec. 26, 2023.

(51) Int. Cl. H04W 72/1263; H04L 5/00; H04W 72/044; H04W 72/0457

(52) U.S. Cl. CPC H04W 72/1263; H04L 5/0098; H04W 72/0457; H04W 72/046

(57) ABSTRACT

Methods and apparatuses for beam operation for single transmit-receive point (TRP) or uplink multi-TRP. A method performed by a user equipment (UE) includes receiving a first unified transmission configuration indication (TCI) state activation or deactivation medium access control (MAC) control element (CE) for single TRP operation and receiving a second unified TCI state activation or deactivation MAC CE for multiple-TRP operation. The method further includes applying a first set of TCI states and a second set of TCI states and receiving, in a TCI field of a beam indication downlink control information (DCI), one or more TCI states mapped to a TCI codepoint from the first or second unified TCI state activation or deactivation MAC CE. The method further includes updating, based on the one or more TCI states, at least one of the first set of TCI states and the second set of TCI states.

### CROSS-REFERENCE TO RELATED AND CLAIM OF PRIORITY

The present application claims priority under 35 U.S.C. § 119 (e) to U.S. Provisional Patent Application No. 63/614,793 filed on Dec. 26, 2023, which is hereby incorporated by reference in its entirety.

### TECHNICAL FIELD

The present disclosure relates generally to wireless communication systems and, more specifically, the present disclosure relates to methods and apparatuses for beam operation for single-transmit-receive point (TRP) or uplink multi-TRP.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam operation for single-TRP or uplink multi-TRP.

In one embodiment, a user equipment (UE) is provided. The UE includes a transceiver configured to receive, in a bandwidth part (BWP) or a serving cell, a first unified transmission configuration indication (TCI) state activation or deactivation medium access control (MAC) control element (CE) for single transmission and reception point (single-TRP) operation and receive, in the BWP or the serving cell, a second unified TCI state activation or deactivation MAC CE for multiple-TRP (multi-TRP) operation. The UE further includes a processor operably coupled with the transceiver. The processor is configured to apply a first set of TCI states and a second set of TCI states. The transceiver is further configured to receive, in a TCI field of a beam indication downlink control information (DCI), one or more TCI states mapped to a TCI codepoint from the first or second unified TCI state activation or deactivation MAC CE. The processor is further configured to update, based on the one or more TCI states, at least one of the first set of TCI states and the second set of TCI states.

In another embodiment, a base station (BS) is provided. The BS includes a processor and a transceiver operably coupled with the processor. The transceiver configured to transmit, in a BWP or a serving cell, a first unified TCI state activation or deactivation MAC CE for single-TRP operation; transmit, in the BWP or the serving cell, a second unified TCI state activation or deactivation MAC CE for multi-TRP operation; and transmit, in a TCI field of a beam indication DCI, one or more TCI states mapped to a TCI codepoint from the first or second unified TCI state activation or deactivation MAC CE. At least one of a first set of TCI states and a second set of TCI states are updated based on the one or more TCI states.

In yet another embodiment, a method performed by a UE is provided. The method includes receiving, in a BWP or a serving cell, a first unified TCI state activation or deactivation MAC CE for single-TRP operation and receiving, in the BWP or the serving cell, a second unified TCI state activation or deactivation MAC CE for multi-TRP operation. The method further includes applying a first set of TCI states and a second set of TCI states and receiving, in a TCI field of a beam indication DCI, one or more TCI states mapped to a TCI codepoint from the first or second unified TCI state activation or deactivation MAC CE. The method further includes updating, based on the one or more TCI states, at least one of the first set of TCI states and the second set of TCI states.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example beam indication downlink control information (DCI) according to embodiments of the present disclosure;

FIG. 8 illustrates a diagram of an example transmission configuration indication (TCI) state activation/deactivation medium access control (MAC) control element (CE) command according to embodiments of the present disclosure; and

FIG. 9 illustrates an example method performed by a UE in a wireless communication system according to embodiments of the present disclosure.

### DETAILED DESCRIPTION

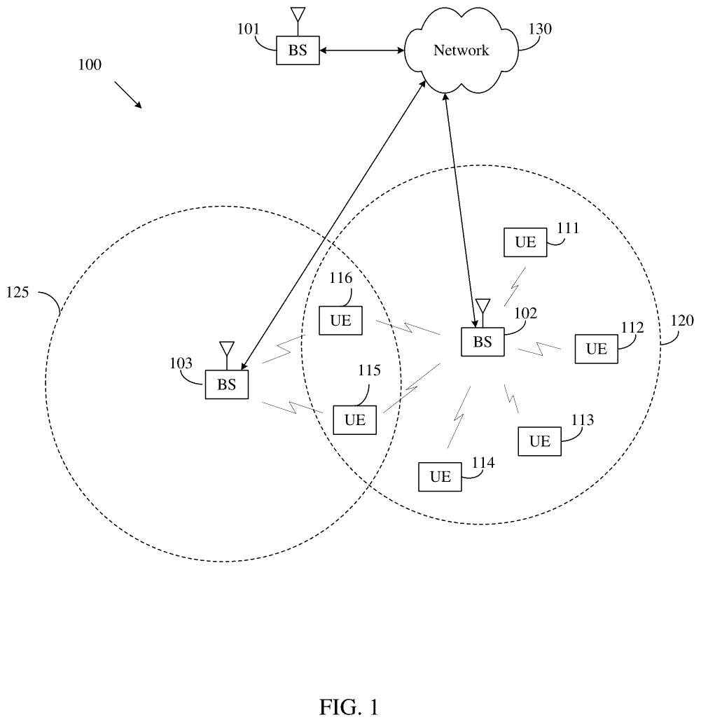

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for beam operation for single-TRP or uplink multi-TRP. In certain embodiments, one or more of the gNBs 101-103 include circuitry, programing, or a combination thereof to support beam operation for single-TRP or uplink multi-TRP.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

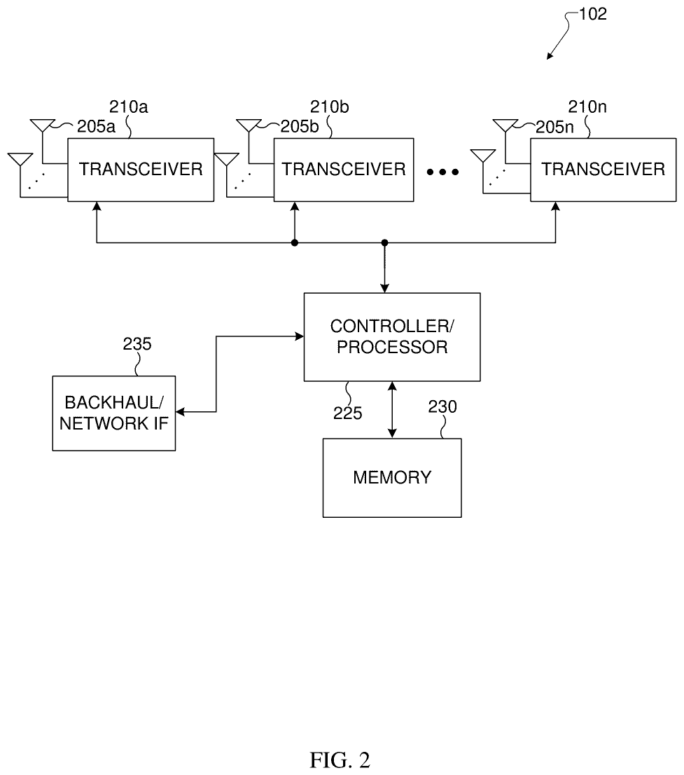

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting beam operation for single-TRP or uplink multi-TRP. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

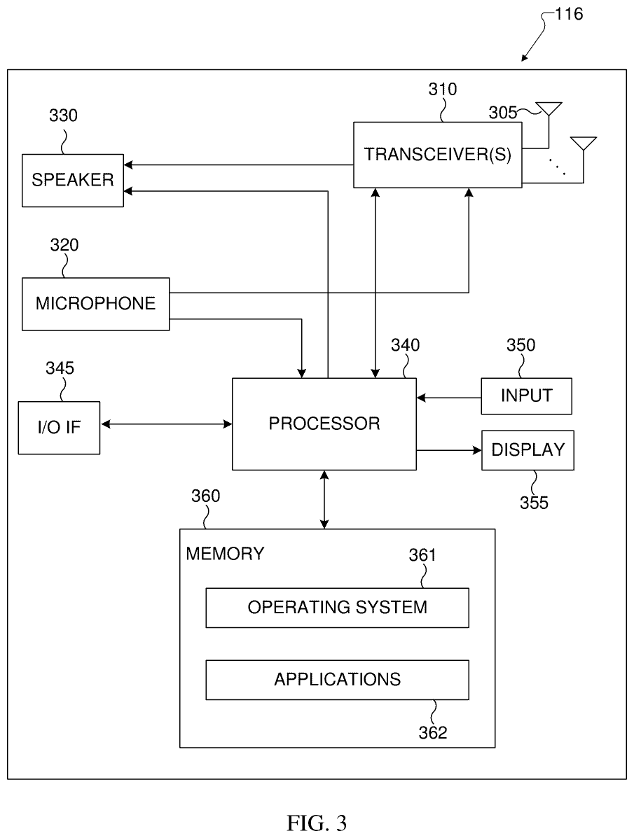

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify beam operation for single-TRP or uplink multi-TRP as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

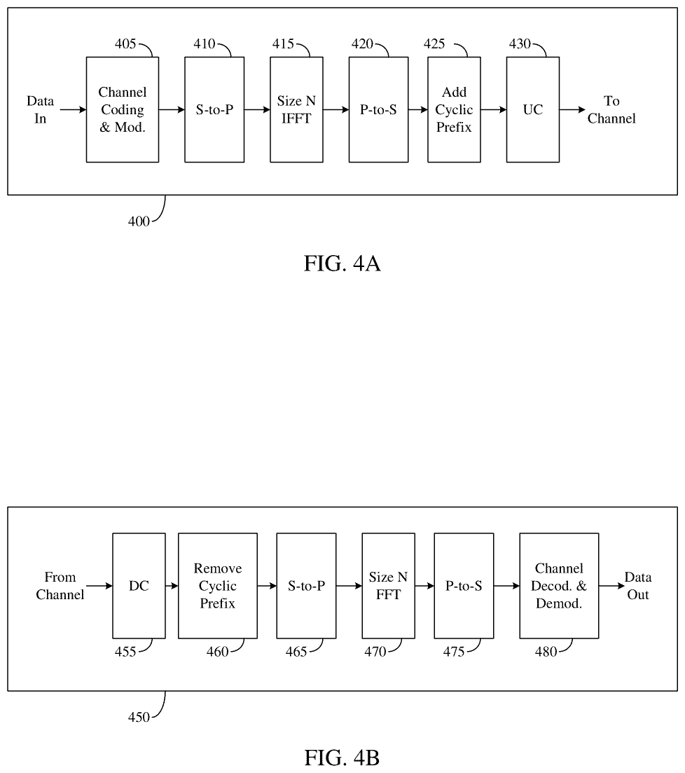

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 perform beam operation for single-TRP or uplink multi-TRP as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

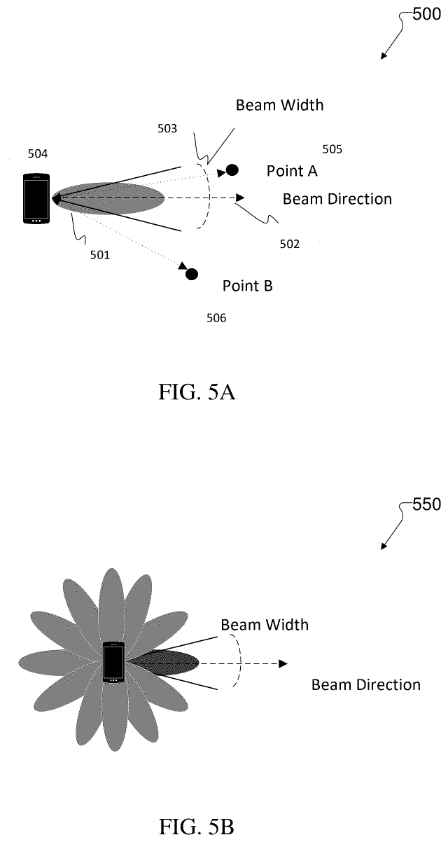

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

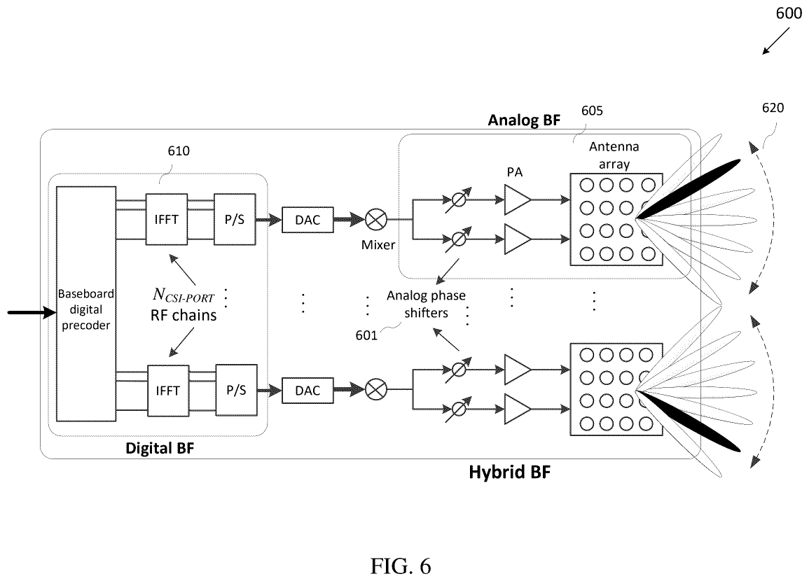

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A TCI state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

In Rel-17 NR, a unified TCI framework was specified for single-TRP operation, wherein an indicated joint/DL/UL TCI state can be used for at least UE-dedicated reception(s) of physical downlink control channel (PDCCH) and physical downlink shared channel (PDSCH), and/or transmission(s) of dynamic-grant/configured-grant based physical uplink shared channel (PUSCH) and on dedicated physical uplink control channel (PUCCH) resources. In Rel-18 NR, the unified TCI framework was extended to multi-TRP operation, wherein a UE (e.g., the UE 116) could respectively use one or both of the two indicated joint/DL/UL TCI states to receive or transmit various DL or UL channels/signals towards or from one or both of the two TRPs.

In a wireless communications system, a UE could receive or transmit various DL channels/signals or UL channels/signals from or to a primary network node, and only transmit UL channels/signals to a plurality of secondary network nodes (i.e., the UE would not receive any DL channels and/or signals from the secondary network nodes) referred to as single-TRP and UL-only multi-TRP operations. However, the design(s) of the Rel-17 and/or Rel-18 unified TCI framework(s) does not account for such system setting(s). Hence, embodiments of the present disclosure recognizes that solutions to address various beam management design issues including at least beam activation and indication for such single-TRP and UL-only multi-TRP operations are needed.

This disclosure is focused on beam management design aspects related to the single-TRP and UL-only multi-TRP operations mentioned herein. In particular, this disclosure provides solutions to address various beam activation and indication design issues for the single-TRP and UL-only multi-TRP operations.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

A UE could receive from the network (e.g., the network 130) a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of component carriers (CCs)/DL bandwidth parts (BWPs), and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s).
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s).
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s).
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and/or (2) at least one TCI codepoint activated therein composing/comprising of one of:
Case 1: a first TCI state for DL channel(s)/signal(s).
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s).
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s).
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and another TCI codepoint activated therein composing/comprising of one of:
Case 2: a first TCI state for DL channel(s)/signal(s) and a second TCI state for DL channel(s)/signal(s).
Case 3: a first TCI state for DL channel(s)/signal(s) and a second TCI state for UL channel(s)/signal(s).
Case 4: a first TCI state for DL channel(s)/signal(s) and a pair of a second TCI state for DL channel(s)/signal(s) and a second TCI state for UL channel(s)/signal(s).
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s).
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET-a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applyIndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH-a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCI-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE (e.g., the UE 116) is configured with dl-OrJointTCI-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI based MTRP” in frequency range 2, or.
If the UE does not report its capability indicating support of “two default beams for S-DCI based MTRP” in frequency range 2 and if the scheduling offset between the reception of the scheduling DCI format 1_0/1_1/1_2 and the scheduled/activated PDSCH reception is equal to or larger than time DurationForQCL
   The UE can be configured by higher layer parameter applyIndicatedTCIState to indicate whether the first, the second, or both of the indicated TCI-state(s) is/are applied to PDSCH reception scheduled or activated by DCI format 1_0. The UE can be configured with applyIndicatedTCIState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type0/0A/2 common search space (CSS) on CORESET #0.
   If the UE is not configured with applyIndicatedTCIState, the first indicated TCI-state is applied to PDSCH reception scheduled or activated by DCI format 1_0.
   When the UE is configured with tciSelection-PresentInDCI jointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
      If the DCI format 1_1/1_2 indicates codepoint “00” for the TCI selection field (or equivalently, the second indicator as specified herein in the present disclosure), the UE shall apply the first one of two indicated joint/DL TCI states to PDSCH demodulation reference signal (DM-RS) port(s) of corresponding PDSCH transmission occasions(s) scheduled or activated by the DCI format 1_1/1_2.
      If the DCI format 1_1/1_2 indicates codepoint “01” for the TCI selection field (or equivalently, the second indicator as specified herein in the present disclosure), the UE shall apply the second one of two indicated joint/DL TCI states to PDSCH DM-RS port(s) of corresponding PDSCH transmission occasion(s) scheduled or activated by the DCI format 1_1/1_2.
      If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
   If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in an UL DCI (e.g., DCI format 0_0/0_1/0_2) that schedules the PUSCH-a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

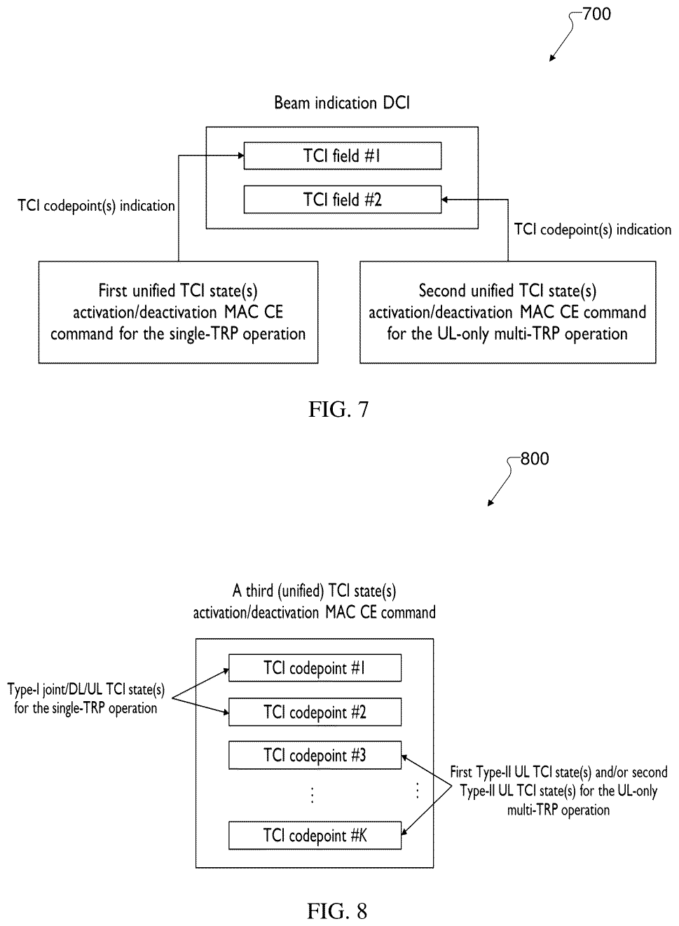

FIG. 7 illustrates a diagram of an example beam indication DCI 700 according to embodiments of the present disclosure. For example, beam indication DCI 700 can be utilized by any of the UEs 111-116 of FIG. 1, such as the UE 111. This example is for illustration only and other embodiments can be used without departing from the scope of the present disclosure.

As specified herein in the present disclosure, a UE could receive from the network a first (unified) TCI state(s) activation MAC CE command—e.g., a Rel-17 unified TCI state(s) activation/deactivation MAC CE command, used to map up to 8 TCI states and/or pairs of TCI states, with each pair comprising of one TCI state for DL channels/signals and/or one TCI state for UL channels/signals, to the codepoints of a TCI field in a beam indication DCI (e.g., UL DCI format 0_0, 0_1 or 0_2 with or without UL grant, and/or DL DCI format 1_0, 1_1 or 1_2 with or without DL assignment) for one or for a set of CCs/DL BWPs. In addition, the UE could also receive from the network a second (unified) TCI state(s) activation MAC CE command—e.g., a Rel-18 enhanced unified TCI state(s) activation/deactivation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of a TCI field in a beam indication DCI (e.g., UL DCI format 0_0, 0_1, or 0_2 with or without UL grant, and/or DL DCI format 1_0, 1_1 or 1_2 with or without DL assignment) for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied.

A UE could be indicated, configured or provided by the network (e.g., based on or according to a corresponding UE's capability or capability signaling), e.g., via higher layer RRC signaling(s)/parameter(s) and/or MAC CE command(s) and/or dynamic DCI based L1 signaling(s), that the single-TRP and UL-only multi-TRP operation(s) is enabled. When the single-TRP and UL-only multi-TRP operation(s) is enabled as specified herein in the present disclosure, a UE could transmit/receive various UL/DL channels and/or signals to/from a primary network node (i.e., the single-TRP here), and/or only transmit UL channels and/or signals to a plurality of secondary network nodes (i.e., the UL-only MTRP here). Furthermore, a UE could also indicate or send to the network a capability signaling indicating that the UE is capable of supporting the single-TRP and UL-only multi-TRP operation(s) as specified herein in the present disclosure. For instance, the UE could receive from the network a higher layer parameter enable ULonlyMTRP (e.g., set to ‘enabled’) to enable the single-TRP and UL-only multi-TRP operation(s) as specified herein in the present disclosure, and/or the UE could be (a) higher layer configured with a list of joint/DL TCI states provided by dl-OrJointTCI-StateList and a list of UL TCI states provided by ul-TCI-StateList for the same CC/BWP/serving cell/band and/or (b) higher layer configured with a first value of unifiedTCI-StateType in the serving cell set to joint and a second value of unifiedTCI-StateType in the serving cell set to separate and/or (c) higher layer configured with a value of unifiedTCI-State Type in the serving cell set to separate to enable the single-TRP and UL-only multi-TRP operation(s) as specified herein in the present disclosure. When the UE is provided/configured/indicated by the network that the single-TRP and UL-only multi-TRP operation(s) is enabled—e.g., when the higher layer parameter enable ULonlyMTRP is provided and/or set to ‘enabled’, and/or when the UE is configured with both dl-OrJointTCI-StateList and ul-TCI-StateList (e.g., for the same CC/BWP/serving cell/band) and/or a first value of unifiedTCI-State Type in the serving cell set to joint and a second value of unifiedTCI-State Type in the serving cell set to separate and/or a value of unifiedTCI-State Type in the serving cell set to separate, the UE could expect or could be expected to receive both the first and the second (unified) TCI state(s) activation/deactivation MAC CE commands as specified herein in the present disclosure for/on/in a/the (same) serving cell or a/the (same) CC or a/the (same) BWP or a/the (same) band.
In one example, the UE could be indicated/provided by the network, e.g., in a first TCI field (or TCI field #1 as in the example shown in FIG. 7) of a beam indication DCI as specified herein in the present disclosure, a TCI codepoint comprising one or more joint/DL/UL TCI states activated from/in the first unified TCI state(s) activation/deactivation MAC CE command (e.g., for the single-TRP operation), and/or, e.g., in a second TCI field (or TCI field #2 as in the example shown in FIG. 7) of a/the (same) beam indication DCI as specified herein in the present disclosure, a TCI codepoint comprising (a set of) one or more joint/DL/UL TCI states activated from/in the second unified TCI state(s) activation/deactivation MAC CE command (e.g., for the UL-only multi-TRP operation). For this case,
   For example, the first (or second) TCI field in the beam indication DCI as specified herein in the present disclosure could correspond to the existing “Transmission Configuration Indication” field in the corresponding DCI format(s) 1_1 and/or 1_2, and the second (or first) TCI field in the beam indication DCI as specified herein in the present disclosure could be a new “Transmission Configuration Indication” field in the corresponding DCI format(s) 1_1 and/or 1_2 or by repurposing one or more bits/codepoints of one or more existing DCI fields in the corresponding DCI format(s) 1_1 and/or 1_2.
   For another example, the UE could be provided/configured/indicated by the network, e.g., via higher layer RRC signaling(s)/parameter(s) and/or MAC CE command(s) and/or dynamic DCI based L1 signaling(s), whether the first or the second TCI field in the beam indication DCI as specified herein in the present disclosure could correspond to the existing “Transmission Configuration Indication” field in the corresponding DCI format(s) 1_1 and/or 1_2, and/or whether the first or the second TCI field in the beam indication DCI as specified herein in the present disclosure could be a new “Transmission Configuration Indication” field in the corresponding DCI format(s) 1_1 and/or 1_2 or by repurposing one or more bits/codepoints of one or more existing DCI fields in the corresponding DCI format(s) 1_1 and/or 1_2.

Furthermore, The UE could be provided/configured/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify presence or absence of the first and/or the second TCI field(s) in the corresponding DCI format(s), e.g., 1_1 and/or 1_2.
For example, the first TCI field could be configured to be present in the corresponding DCI format(s)—e.g., when a higher layer parameter tcilPresentInDCI is provided/configured to the UE (and/or set to ‘enabled’), and the second TCI field is not present or absent in the corresponding DCI format(s)—e.g., when a higher layer parameter tci2PresentInDCI is not provided/configured to the UE (and/or provided/configured to the UE and set to ‘disabled’).
For another example, the second TCI field could be configured to be present in the corresponding DCI format(s)—e.g., when a higher layer parameter tci2PresentInDCI is provided/configured to the UE (and/or set to ‘enabled’), and the first TCI field is not present or absent in the corresponding DCI format(s)—e.g., when a higher layer parameter tci1PresentInDCI is not provided/configured to the UE (and/or provided/configured to the UE and set to ‘disabled’).
For another example, the first TCI field could be configured to be present in the corresponding DCI format(s)—e.g., when a higher layer parameter tcilPresentInDCI is provided/configured to the UE (and/or set to ‘enabled’), and the second TCI field could be configured to be present in the corresponding DCI format(s)—e.g., when a higher layer parameter tci2PresentInDCI is provided/configured to the UE (and/or set to ‘enabled’).
For another example, the first TCI field is not present or absent in the corresponding DCI format(s)—e.g., when a higher layer parameter tcilPresentInDCI is not provided/configured to the UE (and/or provided/configured to the UE and set to ‘disabled’), and the second TCI field is not present or absent in the corresponding DCI format(s)—e.g., when a higher layer parameter tci2PresentInDCI is not provided/configured to the UE (and/or provided/configured to the UE and set to ‘disabled’).
For another example, when/if a (single) TCI field is present in the corresponding DCI format(s), a UE could expect that the TCI field corresponds to the first TCI field.
For another example, when/if a (single) TCI field is present in the corresponding DCI format(s), a UE could expect that the TCI field corresponds to the second TCI field.
For another example, a UE could expect that both of the first and second TCI fields as specified herein in the present disclosure could be present in the corresponding DCI format(s); alternatively, a UE could expect that neither of the first and second TCI fields as specified herein in the present disclosure could be present in the corresponding DCI format(s).
In another example, a UE could receive from the network a first (unified) TCI state(s) activation MAC CE command—e.g., a Rel-17 unified TCI state(s) activation/deactivation MAC CE command, used to map up to M₁, e.g., 8, TCI states and/or pairs of TCI states, with each pair comprising of one TCI state for DL channels/signals and/or one TCI state for UL channels/signals, to the N₁ (i.e., N₁=[log₂M₁]) LSBs (or MSBs) of the codepoints of a TCI field in a beam indication DCI (e.g., UL DCI format 0_0, 0_1 or 0_2 with or without UL grant, and/or DL DCI format 1_0, 1_1 or 1_2 with or without DL assignment) for one or for a set of CCs/DL BWPs. In addition, the UE could also receive from the network a second (unified) TCI state(s) activation MAC CE command—e.g., a Rel-18 enhanced unified TCI state(s) activation/deactivation MAC CE command, used to map up to M₂, e.g., 8, sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals, to the N₂ (i.e., N₂=[log ₂M₂]) MSBs (or LSBs) of the codepoints of a (or the same) TCI field in a/the beam indication DCI (e.g., UL DCI format 0_0, 0_1, or 0_2 with or without UL grant, and/or DL DCI format 1_0, 1_1 or 1_2 with or without DL assignment) for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to (LSBs and/or MSBs of) only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. Whether the LSBs and/or the MSBs of the codepoints of the TCI field in a beam indication DCI (e.g., DCI format 0_0, 0_1 or 0_2 with or without UL grant and/or DCI format 1_0, 1_1 or 1_2 with or without DL assignment) correspond to or are for indicating or mapped to the joint/DL/UL TCI state(s)/pair(s) of TCI states from the first and/or second (unified) TCI state(s) activation MAC CE command(s) could be determined according to: (i) network's configuration(s)/indication(s), e.g., via/by RRC signaling(s)/parameter(s) and/or MAC CE command(s) and/or dynamic DCI based L1 signaling(s)—e.g., according to/based on a corresponding UE's capability or capability signaling, (ii) fixed rule(s)/value(s) in system specification(s), and/or (iii) UE's autonomous determination/selection, which could be further sent to the network, e.g., in/by part of a CSI/beam report and/or UE's capability signaling(s).
For example, the UE could be indicated/provided by the network, e.g., in a ‘Transmission Configuration Indication’ TCI field of a beam indication DCI as specified herein in the present disclosure, a TCI codepoint with the N₁ LSBs of the TCI codepoint comprising one or more joint/DL/UL TCI states activated from/in the first unified TCI state(s) activation/deactivation MAC CE command (e.g., for the single-TRP operation), and/or, with the N₂ MSBs of the TCI codepoint comprising (a set of) one or more joint/DL/UL TCI states activated from/in the second unified TCI state(s) activation/deactivation MAC CE command (e.g., for the UL-only multi-TRP operation).
For another example, the UE (e.g., the UE 116) could be indicated/provided by the network, e.g., in a ‘Transmission Configuration Indication’ TCI field of a beam indication DCI as specified herein in the present disclosure, a TCI codepoint with the N₁ MSBs of the TCI codepoint comprising one or more joint/DL/UL TCI states activated from/in the first unified TCI state(s) activation/deactivation MAC CE command (e.g., for the single-TRP operation), and/or, with the N₂ LSBs of the TCI codepoint comprising (a set of) one or more joint/DL/UL TCI states activated from/in the second unified TCI state(s) activation/deactivation MAC CE command (e.g., for the UL-only multi-TRP operation).

Furthermore, the UE could be provided/configured/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify presence or absence of the joint/DL/UL TCI state(s)/pair(s) of TCI states from the first or second (unified) TCI state(s) activation/deactivation MAC CE command(s) in the corresponding DCI format(s), e.g., 1_1 and/or 1_2.
For example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that the joint/DL/UL TCI state(s)/pair(s) of TCI states from a/the first (unified) TCI state(s) activation/deactivation MAC CE command as specified herein in the present disclosure could be present in the corresponding DCI format(s)—e.g., when a higher layer parameter tcilPresentInDCI is provided/configured to the UE (and/or set to ‘enabled’), and the joint/DL/UL TCI state(s)/pair(s) of TCI states from a/the second (unified) TCI state(s) activation/deactivation MAC CE command as specified herein in the present disclosure is not present or absent in the corresponding DCI format(s)—e.g., when a higher layer parameter tci2PresentInDCI is not provided/configured to the UE (and/or provided/configured to the UE and set to ‘disabled’). For this case/design example, the bits of a TCI codepoint indicated by the TCI field in a beam indication DCI could correspond to or could be used/applied for indicating or mapped to the joint/DL/UL TCI state(s)/pair(s) of TCI state(s) activated from/in the first unified TCI state(s) activation/deactivation MAC CE command as specified herein in the present disclosure.
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that the joint/DL/UL TCI state(s)/pair(s) of TCI states from a/the second (unified) TCI state(s) activation/deactivation MAC CE command as specified herein in the present disclosure could be present in the corresponding DCI format(s)—e.g., when a higher layer parameter tci2PresentInDCI is provided/configured to the UE (and/or set to ‘enabled’), and the joint/DL/UL TCI state(s)/pair(s) of TCI states from a/the first (unified) TCI state(s) activation/deactivation MAC CE command as specified herein in the present disclosure is not present or absent in the corresponding DCI format(s)—e.g., when a higher layer parameter tcilPresentInDCI is not provided/configured to the UE (and/or provided/configured to the UE and set to ‘disabled’). For this case/design example, the bits of a TCI codepoint indicated by the TCI field in a beam indication DCI could correspond to or could be used/applied for indicating or mapped to the joint/DL/UL TCI state(s)/pair(s) of TCI state(s) activated from/in the second unified TCI state(s) activation/deactivation MAC CE command as specified herein in the present disclosure.
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that the joint/DL/UL TCI state(s)/pair(s) of TCI states from both a/the first (unified) TCI state(s) activation/deactivation MAC CE command and a/the second (unified) TCI state(s) activation/deactivation MAC CE command as specified herein in the present disclosure could be present in the corresponding DCI format(s)—e.g., when a higher layer parameter tcilPresentInDCI and a higher layer parameter tci2PresentInDCI are both provided/configured to the UE (and/or set to ‘enabled’). For this case/design example, the LSBs/MSBs of a TCI codepoint indicated by the TCI field in a beam indication DCI could correspond to or could be used/applied for indicating or mapped to the joint/DL/UL TCI state(s)/pair(s) of TCI state(s) activated from/in both the first and second unified TCI state(s) activation/deactivation MAC CE commands according to those specified herein in the present disclosure.
For another example, a UE could be configured/provided/indicated by the network (e.g., the network 130), e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that the joint/DL/UL TCI state(s)/pair(s) of TCI states from neither a/the first (unified) TCI state(s) activation/deactivation MAC CE command nor a/the second (unified) TCI state(s) activation/deactivation MAC CE command as specified herein in the present disclosure is present in the corresponding DCI format(s)—e.g., when a higher layer parameter tcilPresentInDCI and a higher layer parameter tci2PresentInDCI are not provided/configured to the UE (or the higher layer parameters tcilPresentInDCI and tci2PresentInDCI are provided/configured to the UE and set to ‘disabled’). For this case/design example, none of the bits of a TCI codepoint indicated by the TCI field in a beam indication DCI could correspond to or could be used/applied for indicating or mapped to the joint/DL/UL TCI state(s)/pair(s) of TCI state(s) activated from/in the first and/or second unified TCI state(s) activation/deactivation MAC CE command(s) according to those specified herein in the present disclosure, and/or the TCI field could be absent or not present in the corresponding DCI format(s).
For another example, a UE could expect that the bits of a TCI codepoint indicated by the TCI field, if present, in a beam indication DCI could correspond to or could be used/applied for indicating or mapped to the joint/DL/UL TCI state(s)/pair(s) of TCI state(s) activated from/in the first unified TCI state(s) activation/deactivation MAC CE command as specified herein in the present disclosure.
For another example, a UE could expect that the bits of a TCI codepoint indicated by the TCI field, if present, in a beam indication DCI could correspond to or could be used/applied for indicating or mapped to the joint/DL/UL TCI state(s)/pair(s) of TCI state(s) activated from/in the second unified TCI state(s) activation/deactivation MAC CE command as specified herein in the present disclosure.
For another example, a UE could expect that the LSBs/MSBs of a TCI codepoint indicated by the TCI field, if present, in a beam indication DCI could correspond to or could be used/applied for indicating or mapped to the joint/DL/UL TCI state(s)/pair(s) of TCI state(s) activated from/in both the first and second unified TCI state(s) activation/deactivation MAC CE commands according to those specified herein in the present disclosure. Alternatively, a UE could expect that none of the bits of a TCI codepoint indicated by the TCI field, if present, in a beam indication DCI could correspond to or could be used/applied for indicating or mapped to the joint/DL/UL TCI state(s)/pair(s) of TCI state(s) activated from/in the first and/or second unified TCI state(s) activation/deactivation MAC CE command(s) according to those specified herein in the present disclosure. Optionally, a UE could expect that, e.g., when the single-TRP and UL-only multi-TRP operation(s) as specified herein in the present disclosure is enabled, the TCI field could be absent or not present in the corresponding DCI format(s).
In another example, a UE could receive from the network a first (unified) TCI state(s) activation MAC CE command—e.g., a Rel-17 unified TCI state(s) activation/deactivation MAC CE command, used to map up to M₁, e.g., 8, TCI states and/or pairs of TCI states, with each pair comprising of one TCI state for DL channels/signals and/or one TCI state for UL channels/signals, to the first (or last) N₁ (i.e., N₁SM1) codepoints of a TCI field in a beam indication DCI (e.g., UL DCI format 0_0, 0_1 or 0_2 with or without UL grant, and/or DL DCI format 1_0, 1_1 or 1_2 with or without DL assignment) for one or for a set of CCs/DL BWPs. In addition, the UE could also receive from the network a second (unified) TCI state(s) activation MAC CE command—e.g., a Rel-18 enhanced unified TCI state(s) activation/deactivation MAC CE command, used to map up to M₂, e.g., 8, sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals, to the last (or first) N₂ (i.e., N₂≤M₂) of the codepoints of a (or the same) TCI field in a/the beam indication DCI (e.g., UL DCI format 0_0, 0_1, or 0_2 with or without UL grant, and/or DL DCI format 1_0, 1_1 or 1_2 with or without DL assignment) for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. The value(s) of N₁ and/or N₂ could be determined according to: (i) network's configuration(s)/indication(s), e.g., via/by RRC signaling(s)/parameter(s) and/or MAC CE command(s) and/or dynamic DCI based L1 signaling(s)—e.g., according to/based on a corresponding UE's capability or capability signaling, (ii) fixed rule(s)/value(s) in system specification(s), and/or (iii) UE's autonomous determination/selection, which could be further sent to the network, e.g., in/by part of a CSI/beam report and/or UE's capability signaling(s).
For example, the UE could be indicated/provided by the network, e.g., in a ‘Transmission Configuration Indication’ TCI field of a beam indication DCI as specified herein in the present disclosure, a TCI codepoint-corresponding to one of the first N₁ TCI codepoints of the TCI codepoints of/mapped to the TCI field-comprising one or more joint/DL/UL TCI states activated from/in the first unified TCI state(s) activation/deactivation MAC CE command (e.g., for the single-TRP operation), and/or, a TCI codepoint-corresponding to one of the last N₂ TCI codepoints of the TCI codepoints of/mapped to the TCI field-comprising (a set of) one or more joint/DL/UL TCI states activated from/in the second unified TCI state(s) activation/deactivation MAC CE command (e.g., for the UL-only multi-TRP operation).
For another example, the UE could be indicated/provided by the network, e.g., in a ‘Transmission Configuration Indication’ TCI field of a beam indication DCI as specified herein in the present disclosure, a TCI codepoint-corresponding to one of the last N₁ TCI codepoints of the TCI codepoints of/mapped to the TCI field-comprising one or more joint/DL/UL TCI states activated from/in the first unified TCI state(s) activation/deactivation MAC CE command (e.g., for the single-TRP operation), and/or, a TCI codepoint-corresponding to one of the first N₂ TCI codepoints of the TCI codepoints of/mapped to the TCI field-comprising (a set of) one or more joint/DL/UL TCI states activated from/in the second unified TCI state(s) activation/deactivation MAC CE command (e.g., for the UL-only multi-TRP operation).

Furthermore, the UE could be provided/configured/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify whether or not TCI codepoint(s) of a TCI field in the corresponding DCI format(s) could comprise or correspond to or could be mapped to joint/DL/UL TCI state(s)/pair(s) of TCI states from the first and/or second (unified) TCI state(s) activation/deactivation MAC CE command(s) according to those specified herein in the present disclosure.
For example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that each of the TCI codepoints that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command as specified herein in the present disclosure—e.g., when a higher layer parameter typeOfTCICodepoint is provided/configured to the UE (and/or set to ‘0’ (or ‘1’) and/or set to ‘00’ (or ‘01’, ‘10’ or ‘11’) and/or set to ‘strp’); i.e., for this case, none of the TCI codepoints that can be indicated/provided by a/the TCI field in the corresponding DCI format(s) could comprise or provide or could be mapped to joint/DL/UL TCI state(s)/pair(s) of TCI states from a/the second (unified) TCI state(s) activation/deactivation MAC CE command as specified herein in the present disclosure.
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that each of the TCI codepoints that can be indicated/provided by a/the TCI field in the corresponding DCI format(s) could comprise or provide or could be mapped to joint/DL/UL TCI state(s)/pair(s) of TCI states from a/the second (unified) TCI state(s) activation/deactivation MAC CE command as specified herein in the present disclosure—e.g., when a higher layer parameter typeOfTCICodepoint is provided/configured to the UE (and/or set to ‘1’ (or ‘0’) and/or set to ‘01’ (or ‘00’, ‘10’ or ‘11’) and/or set to ‘mtrp’); i.e., for this case, none of the TCI codepoints that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command as specified herein in the present disclosure.
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure—e.g., when a higher layer parameter typeOfTCICodepoint is provided/configured to the UE (and/or set to ‘0’ (or ‘1’) and/or set to ‘10’/′11′ (or ‘00’ or ‘01’) and/or set to ‘both’).
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that none of the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure—e.g., when a higher layer parameter typeOfTCICodepoint is provided/configured to the UE (and/or set to ‘0’ (or ‘1’) and/or set to ‘10’/′11′ (or ‘00’ or ‘01’) and/or set to ‘none’).
For another example, a UE could expect that each of the TCI codepoints that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command as specified herein in the present disclosure.
For another example, a UE could expect that each of the TCI codepoints that can be indicated/provided by a/the TCI field in the corresponding DCI format(s) could comprise or provide or could be mapped to joint/DL/UL TCI state(s)/pair(s) of TCI states from a/the second (unified) TCI state(s) activation/deactivation MAC CE command as specified herein in the present disclosure.
For another example, a UE could expect that the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure. Alternatively, a UE could expect that none of the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure.
In another example, a UE could be indicated/provided/configured by the network, e.g., via/by higher layer RRC signaling(s)/parameter(s) and/or MAC CE command(s) and/or dynamic DCI based L1 signaling(s), whether a/the “Transmission Configuration Indication” TCI field in the corresponding DCI format(s), e.g., 1_1 and/or 1_2, could provide/indicate TCI codepoint(s) that comprises or corresponds to joint/DL/UL TCI state(s)/pair(s) of TCI states from a/the first (unified) TCI state(s) activation/deactivation MAC CE command and/or a/the second (unified) TCI state(s) activation/deactivation MAC CE command as specified herein in the present disclosure. For instance, a DCI indicator, e.g., provided/introduced/indicated/provided in the DCI format(s)—e.g., DCI format(s) 1_1 and/or 1_2—that provides or indicates the TCI field could be used to indicate or provide to the UE whether the TCI field in the corresponding DCI format(s) could provide or indicate TCI codepoint(s) activated from the first (unified) TCI state(s) activation/deactivation MAC CE command and/or the second (unified) TCI state(s) activation/deactivation MAC CE command as specified herein in the present disclosure.
For example, the DCI indicator could be a one-bit indicator. For this case/design example, when/if the one-bit DCI indicator is set to ‘0’ (or ‘1’) or ‘first’, the TCI field in the corresponding DCI format(s) could provide/indicate TCI codepoint(s) activated from the first (unified) TCI state(s) activation/deactivation MAC CE command, and when/if the one-bit DCI indicator is set to ‘1’ (or ‘0’) or ‘second’, the TCI field in the corresponding DCI format(s) could provide/indicate TCI codepoint(s) activated from the second (unified) TCI state(s) activation/deactivation MAC CE command.
For another example, the DCI indicator could be a one-bit indicator, corresponding to the LSB or MSB of an indicated codepoint of the TCI field in the corresponding DCI format(s). For this case/design example, when/if the LSB or MSB of the indicated codepoint (of the TCI field in the corresponding DCI format(s) e.g. 1_1 and/or 1_2) is set to ‘0’ (or ‘1’), the rest of the bits (i.e., except the LSB or MSB) of the TCI field in the corresponding DCI format(s) could provide/indicate TCI codepoint(s) activated from the first (unified) TCI state(s) activation/deactivation MAC CE command, and when/if the LSB or MSB of the indicated codepoint (of the TCI field in the corresponding DCI format(s) e.g. 1_1 and/or 1_2) is set to ‘1’ (or ‘0’), the rest of the bits (i.e., except the LSB or MSB) of the TCI field in the corresponding DCI format(s) could provide/indicate TCI codepoint(s) activated from the second (unified) TCI state(s) activation/deactivation MAC CE command.
For another example, the DCI indicator could correspond to the “New Data Indicator” NDI field in the corresponding DCI format(s)—e.g., the NDI field in the corresponding DCI format(s) could be repurposed to be the DCI indicator. For this case/design example, when/if the NDI field is toggled, the TCI field in the corresponding DCI format(s) could provide/indicate TCI codepoint(s) activated from the first (or second) unified TCI state(s) activation/deactivation MAC CE command; otherwise, the TCI field in the corresponding DCI format(s) could provide/indicate TCI codepoint(s) activated from the second (or first) unified TCI state(s) activation/deactivation MAC CE command.
For another example, the UE could be first provided by the network in PDSCH-Config two values (e.g., 0 and 1) of coresetGroupIndex in ControlResourceSet that configures the corresponding CORESET. For this case/design example, when/if the beam indication DCI that indicates or provides the TCI field is received in a CORESET configured/associated with value 0 (or 1) of coresetGroupIndex, the TCI field in the corresponding DCI format(s) could provide/indicate TCI codepoint(s) activated from the first unified TCI state(s) activation/deactivation MAC CE command, and when/if the beam indication DCI that indicates or provides the TCI field is received in a CORESET configured/associated with value 1 (or 0) of coresetGroupIndex, the TCI field in the corresponding DCI format(s) could provide/indicate TCI codepoint(s) activated from the second unified TCI state(s) activation/deactivation MAC CE command.
For another example, the DCI indicator could be a two-bit indicator. For this case/design example, when/if the two-bit DCI indicator is set to ‘00’ (or ‘01’, ‘10’ or ‘11’) or ‘first’, the TCI field in the corresponding DCI format(s) could provide/indicate TCI codepoint(s) activated from the first (unified) TCI state(s) activation/deactivation MAC CE command, when/if the two-bit DCI indicator is set to ‘01’ (or ‘00’, ‘10’ or ‘11’) or ‘second’, the TCI field in the corresponding DCI format(s) could provide/indicate TCI codepoint(s) activated from the second (unified) TCI state(s) activation/deactivation MAC CE command, when/if the two-bit DCI indicator is set to ‘10’/′11′ (or ‘00’ or ‘01’) or ‘both’, the TCI field in the corresponding DCI format(s) could provide/indicate TCI codepoints or TCI states activated from both the first and second (unified) TCI state(s) activation/deactivation MAC CE commands, and/or when/if the two-bit DCI indicator is set to ‘10’/′11′ (or ‘00’ or ‘01’) or ‘none’, the TCI field in the corresponding DCI format(s) may not provide or indicate any of the TCI codepoint(s) or TCI state(s) activated from either the first or second (unified) TCI state(s) activation/deactivation MAC CE command(s).
For another example, the DCI indicator could be a two-bit indicator, corresponding to the first/last two LSBs or MSBs of an indicated codepoint of the TCI field in the corresponding DCI format(s). For this case/design example, when/if the first/last two LSBs or MSBs of the indicated codepoint (of the TCI field in the corresponding DCI format(s) e.g. 1_1 and/or 1_2) are set to ‘00’ (or ‘01’, ‘10’ or ‘11’), the rest of the bits (i.e., except the first/last two LSBs or MSBs) of the TCI field in the corresponding DCI format(s) could provide/indicate TCI codepoint(s) activated from the first (unified) TCI state(s) activation/deactivation MAC CE command, when/if the first/last two LSBs or MSBs of the indicated codepoint (of the TCI field in the corresponding DCI format(s) e.g. 1_1 and/or 1_2) are set to ‘01’ (or ‘00’, ‘10’ or ‘11’), the rest of the bits (i.e., except the first/last two LSBs or MSBs) of the TCI field in the corresponding DCI format(s) could provide/indicate TCI codepoint(s) activated from the second (unified) TCI state(s) activation/deactivation MAC CE command, when/if the first/last two LSBs or MSBs of the indicated codepoint (of the TCI field in the corresponding DCI format(s) e.g. 1_1 and/or 1_2) are set to ‘10’/′11′ (or ‘00’ or ‘01’), the rest of the bits (i.e., except the first/last two LSBs or MSBs) of the TCI field in the corresponding DCI format(s) could provide/indicate TCI codepoints or TCI states activated from both the first and second (unified) TCI state(s) activation/deactivation MAC CE commands, and/or when/if the first/last two LSBs or MSBs of the indicated codepoint (of the TCI field in the corresponding DCI format(s) e.g. 1_1 and/or 1_2) are set to ‘10’/′11′ (or ‘00’ or ‘01’), the rest of the bits (i.e., except the first/last two LSBs or MSBs) of the TCI field in the corresponding DCI format(s) may not provide/indicate any of the TCI codepoint(s) or TCI state(s) activated from either the first or second (unified) TCI state(s) activation/deactivation MAC CE command(s).
For another example, the UE (e.g., the UE 116) could be first provided by the network in PDSCH-Config four values (e.g., ‘00’, ‘01’, ‘10’ and ‘11’) of coresetGroupIndex in ControlResourceSet that configures the corresponding CORESET. For this case/design example, when/if the beam indication DCI that indicates or provides the TCI field is received in a CORESET configured/associated with value ‘00’ (or ‘01’, ‘10’ or ‘11’) of coresetGroupIndex, the TCI field in the corresponding DCI format(s) could provide/indicate TCI codepoint(s) activated from the first unified TCI state(s) activation/deactivation MAC CE command, when/if the beam indication DCI that indicates or provides the TCI field is received in a CORESET configured/associated with value ‘01’ (or ‘00’, ‘10’ or ‘11’) of coresetGroupIndex, the TCI field in the corresponding DCI format(s) could provide/indicate TCI codepoint(s) activated from the second unified TCI state(s) activation/deactivation MAC CE command, when/if the beam indication DCI that indicates or provides the TCI field is received in a CORESET configured/associated with value ‘10’/′11′ (or ‘00’ or ‘01’) of coresetGroupIndex, the TCI field in the corresponding DCI format(s) could provide/indicate TCI codepoints or TCI states activated from both the first and second unified TCI state(s) activation/deactivation MAC CE commands, and/or when/if the beam indication DCI that indicates or provides the TCI field is received in a CORESET configured/associated with value ‘10’/′11′ (or ‘00’ or ‘01’) of coresetGroupIndex, the TCI field in the corresponding DCI format(s) may not provide/indicate any of the TCI codepoint(s) or TCI state(s) activated from either the first or second unified TCI state(s) activation/deactivation MAC CE command(s).
For another example, the DCI indicator could be a bitmap of length two-denoted by [x y]. For this case/design example, when/if the two-bit DCI indicator is set to ‘00’ (or ‘01’, ‘10’ or ‘11’) or ‘first’, the TCI field in the corresponding DCI format(s) could provide/indicate TCI codepoint(s) activated from the first (unified) TCI state(s) activation/deactivation MAC CE command, when/if the two-bit DCI indicator is set to ‘01’ (or ‘00’, ‘10’ or ‘11’) or ‘second’, the TCI field in the corresponding DCI format(s) could provide/indicate TCI codepoint(s) activated from the second (unified) TCI state(s) activation/deactivation MAC CE command, when/if the two-bit DCI indicator is set to ‘10’/′11′ (or ‘00’ or ‘01’) or ‘both’, the TCI field in the corresponding DCI format(s) could provide/indicate TCI codepoints or TCI states activated from both the first and second (unified) TCI state(s) activation/deactivation MAC CE commands, and/or when/if the two-bit DCI indicator is set to ‘10’/′11′ (or ‘00’ or ‘01’) or ‘none’, the TCI field in the corresponding DCI format(s) may not provide or indicate any of the TCI codepoint(s) or TCI state(s) activated from either the first or second (unified) TCI state(s) activation/deactivation MAC CE command(s).

As specified herein in the present disclosure, the DCI indicator could be a new/dedicated DCI field introduced, specified or implemented in the corresponding DCI format(s), e.g., 1_1 and/or 1_2. Optionally, the DCI indicator could be implemented by repurposing one or more bits of one or more existing DCI fields in the corresponding DCI format(s), e.g., 1_1 and/or 1_2. Furthermore, the UE could be provided/indicated/configured by the network, e.g., via higher layer RRC signaling(s)/parameter(s) and/or MAC CE command(s) and/or dynamic DCI based L1 signaling(s)—e.g., based on or according to a corresponding UE's capability or capability signaling, presence or absence of the DCI indicator in the corresponding DCI format(s). For instance, when a higher layer parameter dynamicStrpMtrpSwitch is provided/configured to a UE (and/or set to ‘enabled’), the UE could expect that the DCI indicator is present in the corresponding DCI format(s); otherwise, i.e., when the higher layer parameter dynamicStrpMtrpSwitch is not provided/configured to the UE (and/or provided/configured to the UE and set to ‘disabled’), the UE could expect that the DCI indicator is absent or not present in the corresponding DCI format(s). When/if the DCI indicator is absent or not present in the corresponding DCI format(s) according to those specified herein in the present disclosure, the UE could be provided/configured/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify whether or not TCI codepoint(s) of a TCI field in the corresponding DCI format(s) could comprise or correspond to or could be mapped to joint/DL/UL TCI state(s)/pair(s) of TCI states from the first and/or second (unified) TCI state(s) activation/deactivation MAC CE command(s) according to those specified herein in the present disclosure.
For example, a UE could be configured/provided/indicated by the network (e.g., the network 130), e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that each of the TCI codepoints that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command as specified herein in the present disclosure—e.g., when a higher layer parameter typeOfTCICodepoint is provided/configured to the UE (and/or set to ‘0’ (or ‘1’) and/or set to ‘00’ (or ‘01’, ‘10’ or ‘11’) and/or set to ‘strp’); i.e., for this case, none of the TCI codepoints that can be indicated/provided by a/the TCI field in the corresponding DCI format(s) could comprise or provide or could be mapped to joint/DL/UL TCI state(s)/pair(s) of TCI states from a/the second (unified) TCI state(s) activation/deactivation MAC CE command as specified herein in the present disclosure.
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that each of the TCI codepoints that can be indicated/provided by a/the TCI field in the corresponding DCI format(s) could comprise or provide or could be mapped to joint/DL/UL TCI state(s)/pair(s) of TCI states from a/the second (unified) TCI state(s) activation/deactivation MAC CE command as specified herein in the present disclosure—e.g., when a higher layer parameter typeOfTCICodepoint is provided/configured to the UE (and/or set to ‘1’ (or ‘0’) and/or set to ‘01’ (or ‘00’, ‘10’ or ‘11’) and/or set to ‘mtrp’); i.e., for this case, none of the TCI codepoints that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command as specified herein in the present disclosure.
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure—e.g., when a higher layer parameter typeOfTCICodepoint is provided/configured to the UE (and/or set to ‘0’ (or ‘1’) and/or set to ‘10’/′11′ (or ‘00’ or ‘01’) and/or set to ‘both’).
For another example, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that none of the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure—e.g., when a higher layer parameter typeOfTCICodepoint is provided/configured to the UE (and/or set to ‘0’ (or ‘1’) and/or set to ‘10’/′11′ (or ‘00’ or ‘01’) and/or set to ‘none’).
For another example, a UE could expect that each of the TCI codepoints that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command as specified herein in the present disclosure.
For another example, a UE could expect that each of the TCI codepoints that can be indicated/provided by a/the TCI field in the corresponding DCI format(s) could comprise or provide or could be mapped to joint/DL/UL TCI state(s)/pair(s) of TCI states from a/the second (unified) TCI state(s) activation/deactivation MAC CE command as specified herein in the present disclosure.
For another example, a UE could expect that the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure. Alternatively, a UE could expect that none of the TCI codepoint(s) that can be indicated/provided by a/the TCI field in the corresponding DCI format(s) could comprise or provide or could be mapped to joint/DL/UL TCI state(s)/pair(s) of TCI states from a/the first (unified) TCI state(s) activation/deactivation MAC CE command or a/the second (unified) TCI state(s) activation/deactivation MAC CE command according to those specified herein in the present disclosure.

A UE could be indicated, configured or provided by the network (e.g., based on or according to a corresponding UE's capability or capability signaling), e.g., via higher layer RRC signaling(s)/parameter(s) and/or MAC CE command(s) and/or dynamic DCI based L1 signaling(s), that the single-TRP and UL-only multi-TRP operation(s) is enabled. When the single-TRP and UL-only multi-TRP operation(s) is enabled as specified herein in the present disclosure, a UE could transmit/receive various UL/DL channels and/or signals to/from a primary network node (i.e., the single-TRP here), and/or only transmit UL channels and/or signals to a plurality of secondary network nodes (i.e., the UL-only MTRP here). Furthermore, a UE could also indicate or send to the network a capability signaling indicating that the UE is capable of supporting the single-TRP and UL-only multi-TRP operation(s) as specified herein in the present disclosure. For instance, the UE could receive from the network a higher layer parameter enable ULonlyMTRP (e.g., set to ‘enabled’) to enable the single-TRP and UL-only multi-TRP operation(s) as specified herein in the present disclosure, and/or the UE could be (a) higher layer configured with a list of joint/DL TCI states provided by dl-OrJointTCI-StateList and a list of UL TCI states provided by ul-TCI-StateList for the same CC/BWP/serving cell/band and/or (b) higher layer configured with a first value of unifiedTCI-StateType in the serving cell set to joint and a second value of unifiedTCI-StateType in the serving cell set to separate and/or (c) higher layer configured with a value of unifiedTCI-State Type in the serving cell set to separate to enable the single-TRP and UL-only multi-TRP operation(s) as specified herein in the present disclosure. When the UE is provided/configured/indicated by the network that the single-TRP and UL-only multi-TRP operation(s) is enabled—e.g., when the higher layer parameter enableULonlyMTRP is provided and/or set to ‘enabled’, and/or when the UE is configured with both dl-OrJointTCI-StateList and ul-TCI-StateList (e.g., for the same CC/BWP/serving cell/band) and/or a first value of unifiedTCI-State Type in the serving cell set to joint and a second value of unifiedTCI-State Type in the serving cell set to separate and/or a value of unifiedTCI-State Type in the serving cell set to separate, the UE could expect or could be expected to receive both the first and the second (unified) TCI state(s) activation/deactivation MAC CE commands as specified herein in the present disclosure for/on/in a/the (same) serving cell or a/the (same) CC or a/the (same) BWP or a/the (same) band. That is, for this case, a UE could receive from the network a first (unified) TCI state(s) activation MAC CE command—e.g., a Rel-17 unified TCI state(s) activation/deactivation MAC CE command, used to map up to M₁, e.g., 8, TCI states and/or pairs of TCI states, with each pair comprising of one TCI state for DL channels/signals and/or one TCI state for UL channels/signals, to the codepoints (e.g., each with N₁=[log ₂M₁] bits) of a TCI field in a first beam indication DCI (e.g., UL DCI format 0_0, 0_1 or 0_2 with or without UL grant, and/or DL DCI format 1_0, 1_1 or 1_2 with or without DL assignment) for one or for a set of CCs/DL BWPs. In addition, the UE could also receive from the network a second (unified) TCI state(s) activation MAC CE command—e.g., a Rel-18 enhanced unified TCI state(s) activation/deactivation MAC CE command, used to map up to M₂, e.g., 8, sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals, to the codepoints (e.g., each with N₂=[log ₂M₂] bits) of a TCI field in a second beam indication DCI (e.g., UL DCI format 0_0, 0_1, or 0_2 with or without UL grant, and/or DL DCI format 1_0, 1_1 or 1_2 with or without DL assignment) for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first (and/or second) MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. For this case, the first and the second beam indication DCIs could be received in different or the same CORESET(s) associated with different or the same time and/or frequency domain resource(s). In addition, a UE could be configured/provided/indicated by the network, e.g., via higher layer RRC signaling(s)/parameter(s) and/or MAC CE command(s) and/or dynamic DCI based L1 signaling(s)—e.g., based on or according to a corresponding UE's capability or capability signaling, and/or according to or based on fixed/default rule(s) in system specification(s), to determine or identify that two beam indication DCIs, e.g., received within a time window, could respectively correspond to the first beam indication DCI and the second beam indication DCI according to those specified herein in the present disclosure, wherein the time window could be determined according to: (i) network's configuration(s)/indication(s), e.g., via/by RRC signaling(s)/parameter(s) and/or MAC CE command(s) and/or dynamic DCI based L1 signaling(s)—e.g., according to/based on a corresponding UE's capability or capability signaling, (ii) fixed rule(s)/value(s)—e.g., a/same slot-in system specification(s), and/or (iii) UE's autonomous determination/selection, which could be further sent to the network, e.g., in/by part of a CSI/beam report and/or UE's capability signaling(s). Optionally, the two beam indication DCIs (respectively correspond to the first and second beam indication DCIs) could be received in two CORESETs associated/configured with higher layer parameter(s) searchSpaceLinking. Among/between the two received beam indication DCIs as specified/described herein,
In one example, the DCI that is received the latest or earliest in time could correspond to the first beam indication DCI, while the other DCI could correspond to the second beam indication DCI.
In another example, the DCI that is received in a CORESET with the lowest or highest CORESET ID/index value could correspond to the first beam indication DCI, while the other DCI could correspond to the second beam indication DCI.
In another example, the DCI that is received in a CORESET with the lowest or highest coresetPoolIndex or coresetGroupIndex value could correspond to the first beam indication DCI, while the other DCI could correspond to the second beam indication DCI.
In another example, the DCI that is received in a CORESET with the lowest or highest control channel element (CCE) index could correspond to the first beam indication DCI, while the other DCI could correspond to the second beam indication DCI.
In another example, the DCI that is received in a CORESET with the lowest or highest search space/search space set ID or index value could correspond to the first beam indication DCI, while the other DCI could correspond to the second beam indication DCI

Throughout the present disclosure, as the second (unified) TCI state(s) activation/deactivation MAC CE command is used for TCI state(s)/beam(s) activation and/or indication for the UL-only multi-TRP operation according to those specified herein in the present disclosure, the second (unified) TCI state(s) activation MAC CE command—e.g., a Rel-18 enhanced unified TCI state(s) activation/deactivation MAC CE command, could be used to map up to M₂, e.g., 8, sets of TCI states, wherein each set could be comprised of up to two (e.g., none, one or two) joint TCI states—each provided by TCI-State-only for UL signals/channels, and/or up to two (e.g., none, one or two) TCI states—each provided by TCI-UL-State—for UL channels/signals, to the codepoints (e.g., each with N₂=[log ₂M₂] bits) of a TCI field in a beam indication DCI (e.g., UL DCI format 0_0, 0_1, or 0_2 with or without UL grant, and/or DL DCI format 1_0, 1_1 or 1_2 with or without DL assignment) for one or for a set of CCs/UL BWPs. That is, the UE may not expect to receive in the second (unified) TCI state(s) activation/deactivation MAC CE command joint or DL TCI state(s)—provided by TCI-State—for DL channels/signals. Optionally, when/if a UE receives in a second (unified) TCI state(s) activation/deactivation MAC CE command according to those specified herein in the present disclosure a joint TCI state provided by TCI-State, the UE could determine or identify whether the joint TCI state could be for: (1) both DL and UL channels/signals, (2) only DL channels/signals, and/or (3) only UL channels/signals, according to: (i) network's configuration(s)/indication(s), e.g., via/by RRC signaling(s)/parameter(s) and/or MAC CE command(s) and/or dynamic DCI based L1 signaling(s)—e.g., according to/based on a corresponding UE's capability or capability signaling, (ii) fixed rule(s)/value(s)—e.g., a/same slot—in system specification(s), and/or (iii) UE's autonomous determination/selection, which could be further sent to the network, e.g., in/by part of a CSI/beam report and/or UE's capability signaling(s). Furthermore, throughout the present disclosure, the value(s) of N₁ and/or N₂ and/or M₁ and/or M₂ could be determined according to: (i) network's configuration(s)/indication(s), e.g., via/by RRC signaling(s)/parameter(s) and/or MAC CE command(s) and/or dynamic DCI based L1 signaling(s)—e.g., according to/based on a corresponding UE's capability or capability signaling, (ii) fixed rule(s)/value(s) in system specification(s), and/or (iii) UE's autonomous determination/selection, which could be further sent to the network, e.g., in/by part of a CSI/beam report and/or UE's capability signaling(s). In addition, throughout the present disclosure, a TCI state from or activated by/from the first (unified) TCI state(s) activation/deactivation MAC CE command could also be referred to as a Type-I TCI state used/applied for the single-TRP operation according to those specified herein in the present disclosure, and a TCI state from or activated by/from the second (unified) TCI state(s) activation/deactivation MAC CE command could also be referred to as a Type-II TCI state used/applied for the UL-only multi-TRP operation according to those specified herein in the present disclosure.

FIG. 8 illustrates a diagram of an example TCI state activation/deactivation MAC CE command 800 according to embodiments of the present disclosure. For example, TCI state activation/deactivation MAC CE command 800 can be utilized by the UE 116 of FIG. 3. This example is for illustration only and other embodiments can be used without departing from the scope of the present disclosure.

A UE could be indicated, configured or provided by the network (e.g., based on or according to a corresponding UE's capability or capability signaling), e.g., via higher layer RRC signaling(s)/parameter(s) and/or MAC CE command(s) and/or dynamic DCI based L1 signaling(s), that the single-TRP and UL-only multi-TRP operation(s) is enabled. When the single-TRP and UL-only multi-TRP operation(s) is enabled as specified herein in the present disclosure, a UE could transmit/receive various UL/DL channels and/or signals to/from a primary network node (i.e., the single-TRP here), and/or only transmit UL channels and/or signals to a plurality of secondary network nodes (i.e., the UL-only MTRP here). Furthermore, a UE could also indicate or send to the network a capability signaling indicating that the UE is capable of supporting the single-TRP and UL-only multi-TRP operation(s) as specified herein in the present disclosure. For instance, the UE could receive from the network a higher layer parameter enable ULonlyMTRP (e.g., set to ‘enabled’) to enable the single-TRP and UL-only multi-TRP operation(s) as specified herein in the present disclosure, and/or the UE could be (a) higher layer configured with a list of joint/DL TCI states provided by dl-OrJointTCI-StateList and a list of UL TCI states provided by ul-TCI-StateList for the same CC/BWP/serving cell/band and/or (b) higher layer configured with a first value of unifiedTCI-StateType in the serving cell set to joint and a second value of unifiedTCI-StateType in the serving cell set to separate and/or (c) higher layer configured with a value of unifiedTCI-State Type in the serving cell set to separate to enable the single-TRP and UL-only multi-TRP operation(s) as specified herein in the present disclosure. When the UE is provided/configured/indicated by the network that the single-TRP and UL-only multi-TRP operation(s) is enabled—e.g., when the higher layer parameter enable ULonlyMTRP is provided and/or set to ‘enabled’, and/or when the UE is configured with both dl-OrJointTCI-StateList and ul-TCI-StateList (e.g., for the same CC/BWP/serving cell/band) and/or a first value of unifiedTCI-State Type in the serving cell set to joint and a second value of unifiedTCI-State Type in the serving cell set to separate and/or a value of unifiedTCI-State Type in the serving cell set to separate, a UE could receive from the network a third (unified) TCI state(s) activation MAC CE command, used to map up to Mₜₒₜ, e.g., 8, Type-I TCI states and/or pairs of Type-I TCI states, with each pair comprising of one Type-I TCI state for DL channels/signals and/or one Type-I TCI state for UL channels/signals, and/or sets of Type-II TCI states, wherein each set could be comprised of up to two (e.g., none, one or two) Type-II TCI states for DL and UL signals/channels, and/or up to two (e.g., none, one or two) Type-II TCI state(s) for DL channels/signals and/or up to two (e.g., none, one or two) Type-II TCI state(s) for UL channels/signals, to the codepoints (e.g., each with Ntot=[log ₂Mₜₒₜ] bits) of a TCI field in a beam indication DCI (e.g., UL DCI format 0_0, 0_1, or 0_2 with or without UL grant, and/or DL DCI format 1_0, 1_1 or 1_2 with or without DL assignment) for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the third MAC CE activation command maps TCI-State(s) and/or TCI-UL-State(s) to only one TCI codepoint, the UE (e.g., the UE 116) shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. According to those specified herein in the present disclosure, as only TCI state(s) for UL channels/signals—e.g., provided by TCI-UL-State(s)—and/or joint TCI state(s)—e.g., provided by TCI-State(s)—applicable to only UL channels/signals (e.g., according to or based on fixed rule(s) in system specification(s) and/or network's configuration(s)/indication(s)/signaling(s)) could be applied/used for the multi-TRP operation (i.e., the so-called UL-only multi-TRP operation), the third (unified) TCI state(s) activation MAC CE command could be used to map up to Mₜₒₜ, e.g., 8, Type-I TCI states and/or pairs of Type-I TCI states, with each pair comprising of one Type-I TCI state for DL channels/signals and/or one Type-I TCI state for UL channels/signals, and/or sets of Type-II TCI states, wherein each set could be comprised of up to two (e.g., none, one or two) Type-II joint TCI states—each provided by TCI-State-applicable for UL signals/channels only, and/or up to two (e.g., none, one or two) Type-II TCI states—each provided by TCI-UL-State—for UL channels/signals, to the codepoints (e.g., each with Ntot=[log ₂ Mₜₒₜ] bits) of a TCI field in a beam indication DCI (e.g., UL DCI format 0_0, 0_1, or 0_2 with or without UL grant, and/or DL DCI format 1_0, 1_1 or 1_2 with or without DL assignment) for one or for a set of CCs/DL BWPs, and if applicable, for one or for a set of CCs/UL BWPs. Here, the Type-I and Type-II TCI states as specified herein in the present disclosure could be respectively used/applied for the single-TRP and UL-only multi-TRP operations according to those specified herein in the present disclosure. In particular, each of the TCI codepoint(s) activated in/by the third (unified) TCI state(s) activation/deactivation MAC CE command could correspond to or could comprise or could be mapped to one of:
Case A: a Type-I joint TCI state provided by TCI-State
Case B: a Type-I DL TCI state provided by TCI-State
Case C: a Type-I UL TCI state provided by TCI-UL-State
Case D: a pair of a Type-I DL TCI state provided by TCI-State and a Type-I UL TCI state provided by TCI-UL-State
Case E: a first Type-II UL TCI state provided by TCI-UL-State
Case F: a second Type-II UL TCI state provided by TCI-UL-State
Case G: a pair of a first Type-II UL TCI state provided by TCI-UL-State and a second Type-II UL TCI state provided by TCI-UL-State
Case H: a Type-I joint TCI state (Case A) and a first Type-II UL TCI state (Case E)
Case I: a Type-I joint TCI state (Case A) and a second Type-II UL TCI state (Case F)
Case J: a Type-I joint TCI state (Case A) and a pair of a first Type-II UL TCI state and a second Type-II UL TCI state (Case G)
Case K: a Type-I DL TCI state (Case B) and a first Type-II UL TCI state (Case E)
Case L: a Type-I DL TCI state (Case B) and a second Type-II UL TCI state (Case F)
Case M: a Type-I DL TCI state (Case B) and a pair of a first Type-II UL TCI state and a second Type-II UL TCI state (Case G)
Case N: a Type-I UL TCI state (Case C) and a first Type-II UL TCI state (Case E)
Case O: a Type-I UL TCI state (Case C) and a second Type-II UL TCI state (Case F)
Case P: a Type-I UL TCI state (Case C) and a pair of a first Type-II UL TCI state and a second Type-II UL TCI state (Case G)
Case Q: a pair of a Type-I DL TCI state and a Type-I UL TCI state (Case D) and a first Type-II UL TCI state (Case E)
Case R: a pair of a Type-I DL TCI state and a Type-I UL TCI state (Case D) and a second Type-II UL TCI state (Case F)
Case S: a pair of a Type-I DL TCI state and a Type-I UL TCI state (Case D) and a pair of a first Type-II UL TCI state and a second Type-II UL TCI state (Case G)

With reference to FIG. 8, one conceptual example of the TCI codepoint(s) mapping in a third (unified) TCI state(s) activation/deactivation MAC CE command according to those specified herein in the present disclosure is provided.

In one example, each of the TCI codepoint(s) activated in/by the third (unified) TCI state(s) activation/deactivation MAC CE command could correspond to or could comprise or could be mapped to one of: Case A, Case B, Case C, Case D, Case E, Case F and Case G according to those specified herein in the present disclosure. In particular,
In one example, when/if a UE is higher layer configured with a first value of unifiedTCI-State Type in the serving cell set to joint and a second value of unifiedTCI-State Type in the serving cell set to separate, each of the TCI codepoint(s) activated in/by the third (unified) TCI state(s) activation/deactivation MAC CE command could correspond to or could comprise or could be mapped to one of: Case A, Case B, Case C, Case D, Case E, Case F and Case G according to those specified herein in the present disclosure, and/or the UE could receive from the network a first (unified) TCI state(s) activation/deactivation MAC CE command as specified herein in the present disclosure providing/indicating/activating one or more joint TCI states for both DL and UL channels/signals, and/or one or more DL TCI states for DL channels/signals, and/or one or more UL TCI states for UL channels/signals, and/or one or more pairs of TCI states with each pair comprising a DL TCI state for DL channels/signals and a UL TCI state for UL channels/signals, and/or the UE could receive from the network a second (unified) TCI state(s) activation/deactivation MAC CE command as specified herein in the present disclosure providing/indicating/activating one or more sets of TCI states with each set comprising up to two UL TCI states for UL channels/signals.
In another example, when/if a UE is higher layer configured with a first value of unifiedTCI-State Type in the serving cell set to joint and a second value of unifiedTCI-State Type in the serving cell set to separate, each of the TCI codepoint(s) activated in/by the third (unified) TCI state(s) activation/deactivation MAC CE command could correspond to or could comprise or could be mapped to one of: Case B, Case C, Case D, Case E, Case F and Case G according to those specified herein in the present disclosure, and/or the UE could receive from the network a first (unified) TCI state(s) activation/deactivation MAC CE command as specified herein in the present disclosure providing/indicating/activating one or more joint TCI states for both DL and UL channels/signals, and/or one or more DL TCI states for DL channels/signals, and/or one or more UL TCI states for UL channels/signals, and/or one or more pairs of TCI states with each pair comprising a DL TCI state for DL channels/signals and a UL TCI state for UL channels/signals, and/or the UE could receive from the network a second (unified) TCI state(s) activation/deactivation MAC CE command as specified herein in the present disclosure providing/indicating/activating one or more sets of TCI states with each set comprising up to two UL TCI states for UL channels/signals.
In another example, when/if a UE is higher layer configured with a value of unifiedTCI-State Type in the serving cell set to joint, the UE could receive from the network a first (unified) TCI state(s) activation/deactivation MAC CE command as specified herein in the present disclosure providing/indicating/activating one or more joint TCI states for both DL and UL channels/signals.
In another example, when/if a UE is higher layer configured with a value of unifiedTCI-State Type in the serving cell set to separate, each of the TCI codepoint(s) activated in/by the third (unified) TCI state(s) activation/deactivation MAC CE command could correspond to or could comprise or could be mapped to one of: Case B, Case C, Case D, Case E, Case F and Case G according to those specified herein in the present disclosure, and/or the UE could receive from the network (e.g., the network 130) a first (unified) TCI state(s) activation/deactivation MAC CE command as specified herein in the present disclosure providing/indicating/activating one or more DL TCI states for DL channels/signals, and/or one or more UL TCI states for UL channels/signals, and/or one or more pairs of TCI states with each pair comprising a DL TCI state for DL channels/signals and a UL TCI state for UL channels/signals, and/or the UE could receive from the network a second (unified) TCI state(s) activation/deactivation MAC CE command as specified herein in the present disclosure providing/indicating/activating one or more sets of TCI states with each set comprising up to two UL TCI states for UL channels/signals.

For this design example/case,
In one example, each of the TCI codepoint(s) from or activated/indicated by/in the third (unified) TCI state(s) activation/deactivation MAC CE command could be associated to/with a first one-bit indicator, wherein the first one-bit indicator(s) could also be indicated/provided in the (same) third (unified) TCI state(s) activation/deactivation MAC CE command as specified herein in the present disclosure. When/if a first one-bit indicator is set to ‘0’ (or ‘1’), the TCI codepoint associated to/with the first one-bit indicator could correspond to or could comprise or could be mapped to one of: Case A, Case B, Case C and Case D according to those specified herein in the present disclosure—i.e., the TCI state(s) mapped to the TCI codepoint could correspond to Type-I TCI state(s) according to those specified herein in the present disclosure; and/or when/if a first one-bit indicator is set to ‘1’ (or ‘0’), the TCI codepoint associated to/with the first one-bit indicator could correspond to or could comprise or could be mapped to one of: Case E, Case F and Case G according to those specified herein in the present disclosure—i.e., the TCI state(s) mapped to the TCI codepoint could correspond to Type-II TCI state(s) according to those specified herein in the present disclosure. For this design example, each of the TCI codepoint(s) from or activated/indicated by/in the third (unified) TCI state(s) activation/deactivation MAC CE command could be associated to/with a bitmap with a first one-bit indicator as specified herein in the present disclosure associated with/to a TCI codepoint as an entry/bit position (e.g., the 1^{st} entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure.
In another example, each of the TCI codepoint(s) from or activated/indicated by/in the third (unified) TCI state(s) activation/deactivation MAC CE command could be associated to/with a second one-bit indicator indicating whether the TCI codepoint associated with/to the second one-bit indicator could have multiple TCI states or single TCI state, wherein the second one-bit indicator(s) could also be indicated/provided in the (same) third (unified) TCI state(s) activation/deactivation MAC CE command as specified herein in the present disclosure. When/if a second one-bit indicator (e.g., a Pi field) is set to ‘0’ (or ‘1’), the TCI codepoint associated to/with the second one-bit indicator (e.g., the i-th TCI codepoint) could correspond to or could comprise or could be mapped to one of: Case A, Case B, Case C, Case E and Case F according to those specified herein in the present disclosure—i.e., the TCI codepoint associated to/with the second one-bit indicator (e.g., the i-th TCI codepoint) could include only the Type-I joint TCI state or the Type-I DL TCI state or the Type-I UL TCI state or the first Type-II UL TCI state or the second Type-II UL TCI state; and/or when/if a second one-bit indicator (e.g., a Pi field) is set to ‘1’ (or ‘0’), the TCI codepoint associated to/with the second one-bit indicator (e.g., the i-th TCI codepoint) could correspond to or could comprise or could be mapped to one of: Case D and Case G according to those specified herein in the present disclosure—i.e., the TCI codepoint associated to/with the second one-bit indicator (e.g., the i-th TCI codepoint) could include the pair of a Type-I DL TCI state and a Type-I UL TCI state or the pair of a first Type-II UL TCI state and a second Type-II UL TCI state. For this design example, each of the TCI codepoint(s) from or activated/indicated by/in the third (unified) TCI state(s) activation/deactivation MAC CE command could be associated to/with a bitmap with a second one-bit indicator as specified herein in the present disclosure associated with/to a TCI codepoint as an entry/bit position (e.g., the 2nd entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure. Furthermore,
For example, each of the TCI state(s) or TCI state ID(s) of a TCI codepoint from or activated/indicated by/in the third (unified) TCI state(s) activation/deactivation MAC CE command could be associated to/with a third one-bit indicator, wherein the third one-bit indicator(s) could also be indicated/provided in the (same) third (unified) TCI state(s) activation/deactivation MAC CE command as specified herein in the present disclosure.
   When/if a TCI state or TCI state ID is of a TCI codepoint corresponding to one of Case A, Case B, Case C and/or Case D according to those specified herein in the present disclosure, the third one-bit indicator associated with/to the TCI state or TCI state ID could indicate whether the TCI state or TCI state ID in the same octet (i.e., of the TCI codepoint) could correspond to a Type-I joint/DL TCI state or a Type-I UL TCI state. For this case, when/if a third one-bit indicator is set to ‘0’ (or ‘1’), the TCI state or TCI state ID in the same octet (i.e., of the TCI codepoint) associated to/with the third one-bit indicator could correspond to a Type-I joint/DL TCI state; when/if a third one-bit indicator is set to ‘1’ (or ‘0’), the TCI state or TCI state ID in the same octet (i.e., of the TCI codepoint) associated to/with the third one-bit indicator could correspond to a Type-I UL TCI state.
   When/if a TCI state or TCI state ID is of a TCI codepoint corresponding to one of Case E, Case F and/or Case G according to those specified herein in the present disclosure, the third one-bit indicator associated with/to the TCI state or TCI state ID could indicate whether the TCI state or TCI state ID in the same octet (i.e., of the TCI codepoint) could correspond to a first (Type-II) UL TCI state or a second (Type-II) UL TCI state. For this case, when/if a third one-bit indicator is set to ‘0’ (or ‘1’), the TCI state or TCI state ID in the same octet (i.e., of the TCI codepoint) associated to/with the third one-bit indicator could correspond to a first (Type-II) UL TCI state; when/if a third one-bit indicator is set to ‘1’ (or ‘0’), the TCI state or TCI state ID in the same octet (i.e., of the TCI codepoint) associated to/with the third one-bit indicator could correspond to a second (Type-II) UL TCI state.
For another example, each of the TCI codepoint(s) from or activated/indicated by/in the third (unified) TCI state(s) activation/deactivation MAC CE command could be associated to/with a fourth indicator indicating whether one or more TCI states or TCI state IDs of the TCI codepoint associated with/to the fourth indicator is present or not, wherein the fourth indicator(s) could also be indicated/provided in the (same) third (unified) TCI state(s) activation/deactivation MAC CE command as specified herein in the present disclosure.
   When/if a TCI state or TCI state ID is of a TCI codepoint corresponding to Case A, Case B and/or Case C according to those specified herein in the present disclosure, one entry of the fourth indicator (e.g., Pij) associated with/to the TCI codepoint (e.g., the i-th TCI codepoint) could indicate whether the TCI state or TCI state ID associated with/to the entry (e.g., the j-th TCI state or TCI state ID of the i-th TCI codepoint) could be present or not. For this case, when/if the 1^{st} entry of a fourth indicator (e.g., Pi1) is set to ‘1’ (or ‘0’), the Type-I joint/DL/UL TCI state as in Case A/B/C (e.g., the 1^{st} TCI state or TCI state ID of the i-th TCI codepoint) associated to/with the 1^{st} entry of the fourth indicator (e.g., Pi1) could be present in the octet (i.e., of the TCI codepoint—e.g., the i-th TCI codepoint); when/if the 1^{st} entry of a fourth indicator (e.g., Pi1) is set to ‘0’ (or ‘1’), the Type-I joint/DL/UL TCI state as in Case A/B/C (e.g., the 1^{st} TCI state or TCI state ID of the i-th TCI codepoint) associated to/with the 1^{st} entry of the fourth indicator (e.g., Pi1) could be absent in the octet (i.e., of the TCI codepoint—e.g., the i-th TCI codepoint). Furthermore, when/if the 2^{nd} entry of a fourth indicator (e.g., Pi2) is set to ‘1’ (or ‘0’), the Type-I joint/DL/UL TCI state as in Case A/B/C (e.g., the 2^{nd} TCI state or TCI state ID of the i-th TCI codepoint) associated to/with the 2^{nd} entry of the fourth indicator (e.g., Pi2) could be present in the octet (i.e., of the TCI codepoint—e.g., the i-th TCI codepoint); when/if the 2^{nd} entry of a fourth indicator (e.g., Pi2) is set to ‘0’ (or ‘1’), the Type-I joint/DL/UL TCI state as in Case A/B/C (e.g., the 2^{nd} TCI state or TCI state ID of the i-th TCI codepoint) associated to/with the 2^{nd} entry of the fourth indicator (e.g., Pi2) could be absent in the octet (i.e., of the TCI codepoint—e.g., the i-th TCI codepoint).
   When/if a TCI state or TCI state ID is of a TCI codepoint corresponding to Case D according to those specified herein in the present disclosure, one entry of the fourth indicator (e.g., Pij) associated with/to the TCI codepoint (e.g., the i-th TCI codepoint) could indicate whether the TCI state or TCI state ID associated with/to the entry (e.g., the j-th TCI state or TCI state ID of the i-th TCI codepoint) could be present or not. For this case, when/if the 1^{st} entry of a fourth indicator (e.g., Pi1) is set to ‘1’ (or ‘0’), the Type-I DL TCI state as in Case D (e.g., the 1^{st} TCI state or TCI state ID of the i-th TCI codepoint) associated to/with the 1^{st} entry of the fourth indicator (e.g., Pi1) could be present in the octet (i.e., of the TCI codepoint—e.g., the i-th TCI codepoint); when/if the 1^{st} entry of a fourth indicator (e.g., Pi1) is set to ‘0’ (or ‘1’), the Type-I DL TCI state as in Case D (e.g., the 1^{st} TCI state or TCI state ID of the i-th TCI codepoint) associated to/with the 1^{st} entry of the fourth indicator (e.g., Pi1) could be absent in the octet (i.e., of the TCI codepoint—e.g., the i-th TCI codepoint). Furthermore, when/if the 2^{nd} entry of a fourth indicator (e.g., Pi2) is set to ‘1’ (or ‘0’), the Type-I UL TCI state as in Case D (e.g., the 2^{nd} TCI state or TCI state ID of the i-th TCI codepoint) associated to/with the 2^{nd} entry of the fourth indicator (e.g., Pi2) could be present in the octet (i.e., of the TCI codepoint—e.g., the i-th TCI codepoint); when/if the 2^{nd} entry of a fourth indicator (e.g., Pi2) is set to ‘0’ (or ‘1’), the Type-I UL TCI state as in Case D (e.g., the 2^{nd} TCI state or TCI state ID of the i-th TCI codepoint) associated to/with the 2^{nd} entry of the fourth indicator (e.g., Pi2) could be absent in the octet (i.e., of the TCI codepoint—e.g., the i-th TCI codepoint).
   When/if a TCI state or TCI state ID is of a TCI codepoint corresponding to Case E, Case F and/or Case G according to those specified herein in the present disclosure, one entry of the fourth indicator (e.g., Pij) associated with/to the TCI codepoint (e.g., the i-th TCI codepoint) could indicate whether the TCI state or TCI state ID associated with/to the entry (e.g., the j-th TCI state or TCI state ID of the i-th TCI codepoint) could be present or not. For this case, when/if the 1^{st} entry of a fourth indicator (e.g., Pi1) is set to ‘1’ (or ‘0’), the first Type-II UL TCI state as in Case E, Case F and/or Case G (e.g., the 1^{st} TCI state or TCI state ID of the i-th TCI codepoint) associated to/with the 1^{st} entry of the fourth indicator (e.g., Pi1) could be present in the octet (i.e., of the TCI codepoint—e.g., the i-th TCI codepoint); when/if the 1^{st} entry of a fourth indicator (e.g., Pi1) is set to ‘0’ (or ‘1’), the first Type-II UL TCI state as in Case E, Case F and/or Case G (e.g., the 1^{st} TCI state or TCI state ID of the i-th TCI codepoint) associated to/with the 1^{st} entry of the fourth indicator (e.g., Pi1) could be absent in the octet (i.e., of the TCI codepoint—e.g., the i-th TCI codepoint). Furthermore, when/if the 2^{nd} entry of a fourth indicator (e.g., Pi2) is set to ‘1’ (or ‘0’), the second Type-II UL TCI state as in Case E, Case F and/or Case G (e.g., the 2^{nd} TCI state or TCI state ID of the i-th TCI codepoint) associated to/with the 2^{nd} entry of the fourth indicator (e.g., Pi2) could be present in the octet (i.e., of the TCI codepoint—e.g., the i-th TCI codepoint); when/if the 2^{nd} entry of a fourth indicator (e.g., Pi2) is set to ‘0’ (or ‘1’), the second Type-II UL TCI state as in Case E, Case F and/or Case G (e.g., the 2^{nd} TCI state or TCI state ID of the i-th TCI codepoint) associated to/with the 2^{nd} entry of the fourth indicator (e.g., Pi2) could be absent in the octet (i.e., of the TCI codepoint—e.g., the i-th TCI codepoint).

For this design example, each of the TCI codepoint(s) from or activated/indicated by/in the third (unified) TCI state(s) activation/deactivation MAC CE command could be associated to/with a bitmap with each entry of a fourth indicator as specified herein in the present disclosure associated with/to a TCI codepoint as an entry/bit position (e.g., the 3rd and/or the 4th entry(s)/bit position(s)) of the bitmap associated to/with the corresponding TCI codepoint, wherein the bitmap(s) could also be indicated/provided in the (same) third (unified) TCI state(s) activation/deactivation MAC CE command as specified herein in the present disclosure.

In one example, each of the TCI codepoint(s) activated in/by the third (unified) TCI state(s) activation/deactivation MAC CE command could correspond to or could comprise or could be mapped to one of: Case A, Case B, Case C, Case D, Case E, Case F, Case G, Case H, Case I, Case J, Case K, Case L, Case M, Case N, Case O, Case P, Case Q, Case R and Case S according to those specified herein in the present disclosure. In particular,
In one example, when/if a UE is higher layer configured with a first value of unifiedTCI-State Type in the serving cell set to joint and a second value of unifiedTCI-State Type in the serving cell set to separate, each of the TCI codepoint(s) activated in/by the third (unified) TCI state(s) activation/deactivation MAC CE command could correspond to or could comprise or could be mapped to one of: Case A, Case B, Case C, Case D, Case E, Case F, Case G, Case H, Case I, Case J, Case K, Case L, Case M, Case N, Case O, Case P, Case Q, Case R and Case S according to those specified herein in the present disclosure, and/or the UE could receive from the network a first (unified) TCI state(s) activation/deactivation MAC CE command as specified herein in the present disclosure providing/indicating/activating one or more joint TCI states for both DL and UL channels/signals, and/or one or more DL TCI states for DL channels/signals, and/or one or more UL TCI states for UL channels/signals, and/or one or more pairs of TCI states with each pair comprising a DL TCI state for DL channels/signals and a UL TCI state for UL channels/signals, and/or the UE could receive from the network a second (unified) TCI state(s) activation/deactivation MAC CE command as specified herein in the present disclosure providing/indicating/activating one or more sets of TCI states with each set comprising up to two UL TCI states for UL channels/signals.
In another example, when/if a UE is higher layer configured with a first value of unifiedTCI-State Type in the serving cell set to joint and a second value of unifiedTCI-State Type in the serving cell set to separate, each of the TCI codepoint(s) activated in/by the third (unified) TCI state(s) activation/deactivation MAC CE command could correspond to or could comprise or could be mapped to one of: Case B, Case C, Case D, Case E, Case F, Case G, Case K, Case L, Case M, Case N, Case O, Case P, Case Q, Case R and Case S according to those specified herein in the present disclosure, and/or the UE could receive from the network a first (unified) TCI state(s) activation/deactivation MAC CE command as specified herein in the present disclosure providing/indicating/activating one or more joint TCI states for both DL and UL channels/signals, and/or one or more DL TCI states for DL channels/signals, and/or one or more UL TCI states for UL channels/signals, and/or one or more pairs of TCI states with each pair comprising a DL TCI state for DL channels/signals and a UL TCI state for UL channels/signals, and/or the UE could receive from the network a second (unified) TCI state(s) activation/deactivation MAC CE command as specified herein in the present disclosure providing/indicating/activating one or more sets of TCI states with each set comprising up to two UL TCI states for UL channels/signals.
In another example, when/if a UE is higher layer configured with a value of unifiedTCI-State Type in the serving cell set to joint, the UE could receive from the network a first (unified) TCI state(s) activation/deactivation MAC CE command as specified herein in the present disclosure providing/indicating/activating one or more joint TCI states for both DL and UL channels/signals.
In another example, when/if a UE is higher layer configured with a value of unifiedTCI-State Type in the serving cell set to separate, each of the TCI codepoint(s) activated in/by the third (unified) TCI state(s) activation/deactivation MAC CE command could correspond to or could comprise or could be mapped to one of: Case B, Case C, Case D, Case E, Case F, Case G, Case K, Case L, Case M, Case N, Case O, Case P, Case Q, Case R and Case S according to those specified herein in the present disclosure, and/or the UE could receive from the network a first (unified) TCI state(s) activation/deactivation MAC CE command as specified herein in the present disclosure providing/indicating/activating one or more DL TCI states for DL channels/signals, and/or one or more UL TCI states for UL channels/signals, and/or one or more pairs of TCI states with each pair comprising a DL TCI state for DL channels/signals and a UL TCI state for UL channels/signals, and/or the UE could receive from the network a second (unified) TCI state(s) activation/deactivation MAC CE command as specified herein in the present disclosure providing/indicating/activating one or more sets of TCI states with each set comprising up to two UL TCI states for UL channels/signals.

For this design example/case,
In one example, each of the TCI codepoint(s) from or activated/indicated by/in the third (unified) TCI state(s) activation/deactivation MAC CE command could be associated to/with a first one-bit indicator, wherein the first one-bit indicator(s) could also be indicated/provided in the (same) third (unified) TCI state(s) activation/deactivation MAC CE command as specified herein in the present disclosure. When/if a first one-bit indicator is set to ‘0’ (or ‘1’), the TCI codepoint associated to/with the first one-bit indicator could correspond to or could comprise or could be mapped to one of: Case A, Case B, Case C, Case D, Case E, Case F and Case G according to those specified herein in the present disclosure—i.e., the TCI state(s) mapped to the TCI codepoint could correspond to either Type-I TCI state(s) for the single-TRP operation or Type-II TCI state(s) for the UL-only multi-TRP operation according to those specified herein in the present disclosure; and/or when/if a first one-bit indicator is set to ‘1’ (or ‘0’), the TCI codepoint associated to/with the first one-bit indicator could correspond to or could comprise or could be mapped to one of: Case H, Case I, Case J, Case K, Case L, Case M, Case N, Case O, Case P, Case Q, Case R and Case S according to those specified herein in the present disclosure—i.e., the TCI state(s) mapped to the TCI codepoint could correspond to a mixture of or both Type-I TCI state(s) for the single-TRP operation and Type-II TCI state(s) for the UL-only multi-TRP operation according to those specified herein in the present disclosure. For this design example, each of the TCI codepoint(s) from or activated/indicated by/in the third (unified) TCI state(s) activation/deactivation MAC CE command could be associated to/with a bitmap with a first one-bit indicator as specified herein in the present disclosure associated with/to a TCI codepoint as an entry/bit position (e.g., the 1 ^{st} entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure.
In another example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a second one-bit indicator, wherein the second one-bit indicator(s) could also be indicated/provided in the (same) third (unified) TCI state(s) activation/deactivation MAC CE command as specified herein in the present disclosure. When/if a second one-bit indicator is set to ‘0’ (or ‘1’), the TCI codepoint (of Case A, Case B, Case C, Case D, Case E, Case F or Case G according to those specified herein in the present disclosure) associated to/with the second one-bit indicator could correspond to or could comprise or could be mapped to one of: Case A, Case B, Case C and Case D according to those specified herein in the present disclosure—i.e., the TCI state(s) mapped to the TCI codepoint could correspond to Type-I TCI state(s) according to those specified herein in the present disclosure; and/or when/if a second one-bit indicator is set to ‘1’ (or ‘0’), the TCI codepoint (of Case A, Case B, Case C, Case D, Case E, Case F or Case G according to those specified herein in the present disclosure) associated to/with the second one-bit indicator could correspond to or could comprise or could be mapped to one of: Case E, Case F and Case G according to those specified herein in the present disclosure—i.e., the TCI state(s) mapped to the TCI codepoint could correspond to Type-II TCI state(s) according to those specified herein in the present disclosure. For this design example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a bitmap with a second one-bit indicator as specified herein in the present disclosure associated with/to a TCI codepoint as an entry/bit position (e.g., the 2^{nd} entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure.
In another example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a third one-bit indicator indicating whether the TCI codepoint associated with/to the third one-bit indicator could have multiple TCI states or single TCI state, wherein the third one-bit indicator(s) could also be indicated/provided in the (same) third (unified) TCI state(s) activation/deactivation MAC CE command as specified herein in the present disclosure. When/if a third one-bit indicator (e.g., a Pi field) is set to ‘0’ (or ‘1’), the TCI codepoint associated to/with the third one-bit indicator (e.g., the i-th TCI codepoint) could correspond to or could comprise or could be mapped to one of: Case A, Case B, Case C, Case E and Case F according to those specified herein in the present disclosure—i.e., the TCI codepoint associated to/with the third one-bit indicator (e.g., the i-th TCI codepoint) could include only the Type-I joint TCI state or the Type-I DL TCI state or the Type-I UL TCI state or the first Type-II UL TCI state or the second Type-II UL TCI state; and/or when/if a third one-bit indicator (e.g., a Pi field) is set to ‘1’ (or ‘0’), the TCI codepoint associated to/with the third one-bit indicator (e.g., the i-th TCI codepoint) could correspond to or could comprise or could be mapped to one of: Case D and Case G according to those specified herein in the present disclosure—i.e., the TCI codepoint associated to/with the third one-bit indicator (e.g., the i-th TCI codepoint) could include the pair of a Type-I DL TCI state and a Type-I UL TCI state or the pair of a first Type-II UL TCI state and a second Type-II UL TCI state. For this design example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a bitmap with a third one-bit indicator as specified herein in the present disclosure associated with/to a TCI codepoint as an entry/bit position (e.g., the 3rd entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure. Furthermore,
   For example, each of the TCI state(s) or TCI state ID(s) of a TCI codepoint of Case A, Case B, Case C, Case D, Case E, Case F and/or Case G according to those specified herein in the present disclosure from or activated/indicated by/in the third (unified) TCI state(s) activation/deactivation MAC CE command could be associated to/with a fourth one-bit indicator, wherein the fourth one-bit indicator(s) could also be indicated/provided in the (same) third (unified) TCI state(s) activation/deactivation MAC CE command as specified herein in the present disclosure.
      When/if a TCI state or TCI state ID is of a TCI codepoint corresponding to one of Case A, Case B, Case C and/or Case D according to those specified herein in the present disclosure, the fourth one-bit indicator associated with/to the TCI state or TCI state ID could indicate whether the TCI state or TCI state ID in the same octet (i.e., of the TCI codepoint) could correspond to a Type-I joint/DL TCI state or a Type-I UL TCI state. For this case, when/if a fourth one-bit indicator is set to ‘0’ (or ‘1’), the TCI state or TCI state ID in the same octet (i.e., of the TCI codepoint) associated to/with the fourth one-bit indicator could correspond to a Type-I joint/DL TCI state; when/if a fourth one-bit indicator is set to ‘1’ (or ‘0’), the TCI state or TCI state ID in the same octet (i.e., of the TCI codepoint) associated to/with the fourth one-bit indicator could correspond to a Type-I UL TCI state.
      When/if a TCI state or TCI state ID is of a TCI codepoint corresponding to one of Case E, Case F and/or Case G according to those specified herein in the present disclosure, the fourth one-bit indicator associated with/to the TCI state or TCI state ID could indicate whether the TCI state or TCI state ID in the same octet (i.e., of the TCI codepoint) could correspond to a first (Type-II) UL TCI state or a second (Type-II) UL TCI state. For this case, when/if a fourth one-bit indicator is set to ‘0’ (or ‘1’), the TCI state or TCI state ID in the same octet (i.e., of the TCI codepoint) associated to/with the fourth one-bit indicator could correspond to a first (Type-II) UL TCI state; when/if a fourth one-bit indicator is set to ‘1’ (or ‘0’), the TCI state or TCI state ID in the same octet (i.e., of the TCI codepoint) associated to/with the fourth one-bit indicator could correspond to a second (Type-II) UL TCI state.
   For another example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a fifth indicator indicating whether one or more TCI states or TCI state IDs of the TCI codepoint associated with/to the fifth indicator is present or not, wherein the fifth indicator(s) could also be indicated/provided in the (same) third (unified) TCI state(s) activation/deactivation MAC CE command as specified herein in the present disclosure.
      When/if a TCI state or TCI state ID is of a TCI codepoint corresponding to Case A, Case B and/or Case C according to those specified herein in the present disclosure, one entry of the fifth indicator (e.g., Pij) associated with/to the TCI codepoint (e.g., the i-th TCI codepoint) could indicate whether the TCI state or TCI state ID associated with/to the entry (e.g., the j-th TCI state or TCI state ID of the i-th TCI codepoint) could be present or not. For this case, when/if the 1^{st} entry of a fifth indicator (e.g., Pi1) is set to ‘1’ (or ‘0’), the Type-I joint/DL/UL TCI state as in Case A/B/C (e.g., the 1^{st} TCI state or TCI state ID of the i-th TCI codepoint) associated to/with the 1^{st} entry of the fifth indicator (e.g., Pi1) could be present in the octet (i.e., of the TCI codepoint—e.g., the i-th TCI codepoint); when/if the 1^{st} entry of a fifth indicator (e.g., Pi1) is set to ‘0’ (or ‘1’), the Type-I joint/DL/UL TCI state as in Case A/B/C (e.g., the 1^{st} TCI state or TCI state ID of the i-th TCI codepoint) associated to/with the 1^{st} entry of the fifth indicator (e.g., Pi1) could be absent in the octet (i.e., of the TCI codepoint—e.g., the i-th TCI codepoint). Furthermore, when/if the 2^{nd} entry of a fifth indicator (e.g., Pi2) is set to ‘1’ (or ‘0’), the Type-I joint/DL/UL TCI state as in Case A/B/C (e.g., the 2^{nd} TCI state or TCI state ID of the i-th TCI codepoint) associated to/with the 2^{nd} entry of the fifth indicator (e.g., Pi2) could be present in the octet (i.e., of the TCI codepoint—e.g., the i-th TCI codepoint); when/if the 2^{nd} entry of a fifth indicator (e.g., Pi2) is set to ‘0’ (or ‘1’), the Type-Ijoint/DL/UL TCI state as in Case A/B/C (e.g., the 2^{nd} TCI state or TCI state ID of the i-th TCI codepoint) associated to/with the 2^{nd} entry of the fifth indicator (e.g., Pi2) could be absent in the octet (i.e., of the TCI codepoint—e.g., the i-th TCI codepoint).
      When/if a TCI state or TCI state ID is of a TCI codepoint corresponding to Case D according to those specified herein in the present disclosure, one entry of the fifth indicator (e.g., Pij) associated with/to the TCI codepoint (e.g., the i-th TCI codepoint) could indicate whether the TCI state or TCI state ID associated with/to the entry (e.g., the j-th TCI state or TCI state ID of the i-th TCI codepoint) could be present or not. For this case, when/if the 1^{st} entry of a fifth indicator (e.g., Pi1) is set to ‘1’ (or ‘0’), the Type-I DL TCI state as in Case D (e.g., the 1^{st} TCI state or TCI state ID of the i-th TCI codepoint) associated to/with the 1^{st} entry of the fifth indicator (e.g., Pi1) could be present in the octet (i.e., of the TCI codepoint—e.g., the i-th TCI codepoint); when/if the 1^{st} entry of a fifth indicator (e.g., Pi1) is set to ‘0’ (or ‘1’), the Type-I DL TCI state as in Case D (e.g., the 1^{st} TCI state or TCI state ID of the i-th TCI codepoint) associated to/with the 1^{st} entry of the fifth indicator (e.g., Pi1) could be absent in the octet (i.e., of the TCI codepoint—e.g., the i-th TCI codepoint). Furthermore, when/if the 2^{nd} entry of a fifth indicator (e.g., Pi2) is set to ‘1’ (or ‘0’), the Type-I UL TCI state as in Case D (e.g., the 2^{nd} TCI state or TCI state ID of the i-th TCI codepoint) associated to/with the 2^{nd} entry of the fifth indicator (e.g., Pi2) could be present in the octet (i.e., of the TCI codepoint—e.g., the i-th TCI codepoint); when/if the 2^{nd} entry of a fifth indicator (e.g., Pi2) is set to ‘0’ (or ‘1’), the Type-I UL TCI state as in Case D (e.g., the 2^{nd} TCI state or TCI state ID of the i-th TCI codepoint) associated to/with the 2^{nd} entry of the fifth indicator (e.g., Pi2) could be absent in the octet (i.e., of the TCI codepoint—e.g., the i-th TCI codepoint).
      When/if a TCI state or TCI state ID is of a TCI codepoint corresponding to Case E, Case F and/or Case G according to those specified herein in the present disclosure, one entry of the fifth indicator (e.g., Pij) associated with/to the TCI codepoint (e.g., the i-th TCI codepoint) could indicate whether the TCI state or TCI state ID associated with/to the entry (e.g., the j-th TCI state or TCI state ID of the i-th TCI codepoint) could be present or not. For this case, when/if the 1^{st} entry of a fifth indicator (e.g., Pi1) is set to ‘1’ (or ‘0’), the first Type-II UL TCI state as in Case E, Case F and/or Case G (e.g., the 1^{st} TCI state or TCI state ID of the i-th TCI codepoint) associated to/with the 1^{st} entry of the fifth indicator (e.g., Pi1) could be present in the octet (i.e., of the TCI codepoint—e.g., the i-th TCI codepoint); when/if the 1^{st} entry of a fifth indicator (e.g., Pi1) is set to ‘0’ (or ‘1’), the first Type-II UL TCI state as in Case E, Case F and/or Case G (e.g., the 1^{st} TCI state or TCI state ID of the i-th TCI codepoint) associated to/with the 1^{st} entry of the fifth indicator (e.g., Pi1) could be absent in the octet (i.e., of the TCI codepoint—e.g., the i-th TCI codepoint). Furthermore, when/if the 2^{nd} entry of a fifth indicator (e.g., Pi2) is set to ‘1’ (or ‘0’), the second Type-II UL TCI state as in Case E, Case F and/or Case G (e.g., the 2^{nd} TCI state or TCI state ID of the i-th TCI codepoint) associated to/with the 2^{nd} entry of the fifth indicator (e.g., Pi2) could be present in the octet (i.e., of the TCI codepoint—e.g., the i-th TCI codepoint); when/if the 2^{nd} entry of a fifth indicator (e.g., Pi2) is set to ‘0’ (or ‘1’), the second Type-II UL TCI state as in Case E, Case F and/or Case G (e.g., the 2^{nd} TCI state or TCI state ID of the i-th TCI codepoint) associated to/with the 2^{nd} entry of the fifth indicator (e.g., Pi2) could be absent in the octet (i.e., of the TCI codepoint—e.g., the i-th TCI codepoint).

For this design example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a bitmap with each entry of a fifth indicator as specified herein in the present disclosure associated with/to a TCI codepoint as an entry/bit position (e.g., the 4th and/or the 5^{th} entry(s)/bit position(s)) of the bitmap associated to/with the corresponding TCI codepoint, wherein the bitmap(s) could also be indicated/provided in the (same) third (unified) TCI state(s) activation/deactivation MAC CE command as specified herein in the present disclosure.
In another example, each of the TCI codepoint(s) of Case H, Case I, Case J, Case K, Case L, Case M, Case N, Case O, Case P, Case Q, Case R and/or Case S according to those specified herein in the present disclosure from or activated/indicated by/in the third (unified) TCI state(s) activation/deactivation MAC CE command could comprise or include or contain or provide or correspond to two parts, wherein part 1 could comprise or correspond to or could be mapped to Type-I joint/DL/UL TCI state(s)—e.g., corresponding to Case A, Case B, Case C and/or Case D as specified herein in the present disclosure, and part 2 could comprise or correspond to or could be mapped to first/second Type-II UL TCI state(s)—e.g., corresponding to Case E, Case F and/or Case G as specified herein in the present disclosure. Furthermore, part 1 (or part 2) of a TCI codepoint could correspond to or comprise or could be mapped to the first two entries or TCI state IDs of the TCI codepoint, and part 2 (or part 1) of a TCI codepoint could correspond to or comprise or could be mapped to the last two entries or TCI state IDs of the TCI codepoint. Alternatively, the association(s)/mapping(s) between part 1/2 of a TCI codepoint and the first/last two entries or TCI state IDs of the TCI codepoint could be determined or identified according to: (i) network's configuration(s)/indication(s), e.g., via/by RRC signaling(s)/parameter(s) and/or MAC CE command(s) and/or dynamic DCI based L1 signaling(s)—e.g., according to/based on a corresponding UE's capability or capability signaling, (ii) fixed rule(s)/value(s) in system specification(s), and/or (iii) UE's autonomous determination/selection, which could be further sent to the network (e.g., the network 130), e.g., in/by part of a CSI/beam report and/or UE's capability signaling(s). For this case/design example, part 1 of a TCI codepoint of Case H, Case I, Case J, Case K, Case L, Case M, Case N, Case O, Case P, Case Q, Case R and/or Case S according to those specified herein in the present disclosure could be associated to/with a sixth one-bit indicator indicating whether part 1 of the TCI codepoint associated with/to the sixth one-bit indicator could have multiple TCI states or single TCI state, wherein the sixth one-bit indicator(s) could also be indicated/provided in the (same) third (unified) TCI state(s) activation/deactivation MAC CE command as specified herein in the present disclosure. When/if a sixth one-bit indicator (e.g., a Pi field) is set to ‘0’ (or ‘1’), part 1 of the TCI codepoint associated to/with the sixth one-bit indicator (e.g., part 1 of the i-th TCI codepoint) could correspond to or could comprise or could be mapped to one of: Case A, Case B and Case C according to those specified herein in the present disclosure—i.e., part 1 of the TCI codepoint associated to/with the sixth one-bit indicator (e.g., part 1 of the i-th TCI codepoint) could include only the Type-I joint TCI state or the Type-I DL TCI state or the Type-I UL TCI state; and/or when/if a sixth one-bit indicator (e.g., a Pi field) is set to ‘1’ (or ‘0’), part 1 of the TCI codepoint associated to/with the sixth one-bit indicator (e.g., part 1 of the i-th TCI codepoint) could correspond to or could comprise or could be mapped to Case D according to those specified herein in the present disclosure—i.e., part 1 of the TCI codepoint associated to/with the sixth one-bit indicator (e.g., part 1 of the i-th TCI codepoint) could include the pair of a Type-I DL TCI state and a Type-I UL TCI state. For this design example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a bitmap with a sixth one-bit indicator as specified herein in the present disclosure associated with/to part 1 of a TCI codepoint as an entry/bit position (e.g., the 6^{th} entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure. Additionally, part 2 of a TCI codepoint of Case H, Case I, Case J, Case K, Case L, Case M, Case N, Case O, Case P, Case Q, Case R and/or Case S according to those specified herein in the present disclosure could be associated to/with a seventh one-bit indicator indicating whether part 2 of the TCI codepoint associated with/to the seventh one-bit indicator could have multiple TCI states or single TCI state, wherein the seventh one-bit indicator(s) could also be indicated/provided in the (same) third (unified) TCI state(s) activation/deactivation MAC CE command as specified herein in the present disclosure. When/if a seventh one-bit indicator (e.g., a Qi field) is set to ‘0’ (or ‘1’), part 2 of the TCI codepoint associated to/with the seventh one-bit indicator (e.g., part 2 of the i-th TCI codepoint) could correspond to or could comprise or could be mapped to one of: Case E and Case F according to those specified herein in the present disclosure—i.e., part 2 of the TCI codepoint associated to/with the seventh one-bit indicator (e.g., part 2 of the i-th TCI codepoint) could include only the first Type-II UL TCI state or the second Type-II UL TCI state; and/or when/if a seventh one-bit indicator (e.g., a Qi field) is set to ‘1’ (or ‘0’), part 2 of the TCI codepoint associated to/with the seventh one-bit indicator (e.g., part 2 of the i-th TCI codepoint) could correspond to or could comprise or could be mapped to Case G according to those specified herein in the present disclosure—i.e., part 2 of the TCI codepoint associated to/with the seventh one-bit indicator (e.g., part 2 of the i-th TCI codepoint) could include the pair of a first Type-II UL TCI state and a second Type-II UL TCI state. For this design example, each of the TCI codepoint(s) of Case A, Case B, Case C, Case D, Case E, Case F and/or Case G according to those specified herein in the present disclosure from or activated/indicated by/in the third (unified) TCI state(s) activation/deactivation MAC CE command could be associated to/with a bitmap with a seventh one-bit indicator as specified herein in the present disclosure associated with/to part 2 of a TCI codepoint as an entry/bit position (e.g., the 7^{th} entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure. Furthermore,
For example, each of the TCI state(s) or TCI state ID(s) in part 1 of a TCI codepoint of Case H, Case I, Case J, Case K, Case L, Case M, Case N, Case O, Case P, Case Q, Case R and/or Case S according to those specified herein in the present disclosure from or activated/indicated by/in the third (unified) TCI state(s) activation/deactivation MAC CE command could be associated to/with a eighth one-bit indicator, wherein the eighth one-bit indicator(s) could also be indicated/provided in the (same) third (unified) TCI state(s) activation/deactivation MAC CE command as specified herein in the present disclosure. When/if a TCI state or TCI state ID belongs to part 1 of a TCI codepoint corresponding to one of Case H, Case I, Case J, Case K, Case L, Case M, Case N, Case O, Case P, Case Q, Case R and/or Case S according to those specified herein in the present disclosure, the eighth one-bit indicator associated with/to the TCI state or TCI state ID could indicate whether the TCI state or TCI state ID in the same octet (i.e., in part 1 of the TCI codepoint) could correspond to a Type-I joint/DL TCI state or a Type-I UL TCI state. For this case, when/if a eighth one-bit indicator is set to ‘0’ (or ‘1’), the TCI state or TCI state ID in the same octet (i.e., in part 1 of the TCI codepoint) associated to/with the eighth one-bit indicator could correspond to a Type-I joint/DL TCI state; when/if a eighth one-bit indicator is set to ‘1’ (or ‘0’), the TCI state or TCI state ID in the same octet (i.e., in part 1 of the TCI codepoint) associated to/with the eighth one-bit indicator could correspond to a Type-I UL TCI state.
For another example, each of the TCI state(s) or TCI state ID(s) in part 2 of a TCI codepoint of Case H, Case I, Case J, Case K, Case L, Case M, Case N, Case O, Case P, Case Q, Case R and/or Case S according to those specified herein in the present disclosure from or activated/indicated by/in the third (unified) TCI state(s) activation/deactivation MAC CE command could be associated to/with a ninth one-bit indicator, wherein the ninth one-bit indicator(s) could also be indicated/provided in the (same) third (unified) TCI state(s) activation/deactivation MAC CE command as specified herein in the present disclosure. When/if a TCI state or TCI state ID belongs to part 2 of a TCI codepoint corresponding to one of Case H, Case I, Case J, Case K, Case L, Case M, Case N, Case O, Case P, Case Q, Case R and/or Case S according to those specified herein in the present disclosure, the ninth one-bit indicator associated with/to the TCI state or TCI state ID could indicate whether the TCI state or TCI state ID in the same octet (i.e., in part 2 of the TCI codepoint) could correspond to a first (Type-II) UL TCI state or a second (Type-II) UL TCI state. For this case, when/if a ninth one-bit indicator is set to ‘0’ (or ‘1’), the TCI state or TCI state ID in the same octet (i.e., in part 2 of the TCI codepoint) associated to/with the ninth one-bit indicator could correspond to a first (Type-II) UL TCI state; when/if a ninth one-bit indicator is set to ‘1’ (or ‘0’), the TCI state or TCI state ID in the same octet (i.e., in part 2 of the TCI codepoint) associated to/with the ninth one-bit indicator could correspond to a second (Type-II) UL TCI state.
For another example, part 1 of each of the TCI codepoint(s) of Case H, Case I, Case J, Case K, Case L, Case M, Case N, Case O, Case P, Case Q, Case R and/or Case S according to those specified herein in the present disclosure from or activated/indicated by/in the third (unified) TCI state(s) activation/deactivation MAC CE command could be associated to/with a tenth indicator indicating whether one or more TCI states or TCI state IDs in part 1 of the TCI codepoint associated with/to the tenth indicator is present or not, wherein the tenth indicator(s) could also be indicated/provided in the (same) third (unified) TCI state(s) activation/deactivation MAC CE command as specified herein in the present disclosure.
   When/if a TCI state or TCI state ID belongs to part 1 of a TCI codepoint corresponding to Case H, Case I, Case J, Case K, Case L, Case M, Case N, Case O and/or Case P according to those specified herein in the present disclosure, one entry of the tenth indicator (e.g., Pij) associated with/to part 1 of the TCI codepoint (e.g., part 1 of the i-th TCI codepoint) could indicate whether the TCI state or TCI state ID associated with/to the entry (e.g., the j-th TCI state or TCI state ID in part 1 of the i-th TCI codepoint) could be present or not. For this case, when/if the 1^{st} entry of a tenth indicator (e.g., Pi1) is set to ‘1’ (or ‘0’), the Type-I joint/DL/UL TCI state as in Case H to Case P (e.g., the 1^{st} TCI state or TCI state ID in part 1 of the i-th TCI codepoint) associated to/with the 1^{st} entry of the tenth indicator (e.g., Pi1) could be present in the octet (i.e., part 1 of the TCI codepoint—e.g., part 1 of the i-th TCI codepoint); when/if the 1^{st} entry of a tenth indicator (e.g., Pi1) is set to ‘0’ (or ‘1’), the Type-I joint/DL/UL TCI state as in Case H to Case P (e.g., the 1^{st} TCI state or TCI state ID in part 1 of the i-th TCI codepoint) associated to/with the 1^{st} entry of the tenth indicator (e.g., Pi1) could be absent in the octet (i.e., part 1 of the TCI codepoint—e.g., part 1 of the i-th TCI codepoint). Furthermore, when/if the 2^{nd} entry of a tenth indicator (e.g., Pi2) is set to ‘1’ (or ‘0’), the Type-I joint/DL/UL TCI state as in Case H to Case P (e.g., the 2^{nd} TCI state or TCI state ID in part 2 of the i-th TCI codepoint) associated to/with the 2^{nd} entry of the tenth indicator (e.g., Pi2) could be present in the octet (i.e., part 1 of the TCI codepoint—e.g., part 1 of the i-th TCI codepoint); when/if the 2^{nd} entry of a tenth indicator (e.g., Pi2) is set to ‘0’ (or ‘1’), the Type-I joint/DL/UL TCI state as in Case H to Case P (e.g., the 2^{nd} TCI state or TCI state ID in part 1 of the i-th TCI codepoint) associated to/with the 2^{nd} entry of the tenth indicator (e.g., Pi2) could be absent in the octet (i.e., part 1 of the TCI codepoint—e.g., part 1 of the i-th TCI codepoint).
   When/if a TCI state or TCI state ID belongs to part 1 of a TCI codepoint corresponding to Case Q, Case R and/or Case S according to those specified herein in the present disclosure, one entry of the tenth indicator (e.g., Pij) associated with/to part 1 of the TCI codepoint (e.g., part 1 of the i-th TCI codepoint) could indicate whether the TCI state or TCI state ID associated with/to the entry (e.g., the j-th TCI state or TCI state ID in part 1 of the i-th TCI codepoint) could be present or not. For this case, when/if the 1^{st} entry of a tenth indicator (e.g., Pi1) is set to ‘1’ (or ‘0’), the Type-I DL TCI state as in Case Q, Case R and/or Case S (e.g., the 1^{st} TCI state or TCI state ID in part 1 of the i-th TCI codepoint) associated to/with the 1^{st} entry of the tenth indicator (e.g., Pi1) could be present in the octet (i.e., in part 1 of the TCI codepoint—e.g., in part 1 of the i-th TCI codepoint); when/if the 1^{st} entry of a tenth indicator (e.g., Pi1) is set to ‘0’ (or ‘1’), the Type-I DL TCI state as in Case Q, Case R and/or Case S (e.g., the 1^{st} TCI state or TCI state ID in part 1 of the i-th TCI codepoint) associated to/with the 1^{st} entry of the tenth indicator (e.g., Pi1) could be absent in the octet (i.e., in part 1 of the TCI codepoint—e.g., in part 1 of the i-th TCI codepoint). Furthermore, when/if the 2^{nd} entry of a tenth indicator (e.g., Pi2) is set to ‘1’ (or ‘0’), the Type-I UL TCI state as in Case Q, Case R and/or Case S (e.g., the 2^{nd} TCI state or TCI state ID in part 1 of the i-th TCI codepoint) associated to/with the 2^{nd} entry of the tenth indicator (e.g., Pi2) could be present in the octet (i.e., in part 1 of the TCI codepoint—e.g., in part 1 of the i-th TCI codepoint); when/if the 2^{nd} entry of a tenth indicator (e.g., Pi2) is set to ‘0’ (or ‘1’), the Type-I UL TCI state as in Case Q, Case R and/or Case S (e.g., the 2^{nd} TCI state or TCI state ID in part 1 of the i-th TCI codepoint) associated to/with the 2^{nd} entry of the tenth indicator (e.g., Pi2) could be absent in the octet (i.e., in part 1 of the TCI codepoint—e.g., in part 1 of the i-th TCI codepoint).

For this design example, each of the TCI codepoint(s) of Case H, Case I, Case J, Case K, Case L, Case M, Case N, Case O, Case P, Case Q, Case R and/or Case S according to those specified herein in the present disclosure from or activated/indicated by/in the third (unified) TCI state(s) activation/deactivation MAC CE command could be associated to/with a bitmap with a tenth one-bit indicator as specified herein in the present disclosure associated with/to part 1 of a TCI codepoint as an entry/bit position (e.g., the 8^{th} entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure.

For another example, part 2 of each of the TCI codepoint(s) of Case H, Case I, Case J, Case K, Case L, Case M, Case N, Case O, Case P, Case Q, Case R and/or Case S according to those specified herein in the present disclosure from or activated/indicated by/in the third (unified) TCI state(s) activation/deactivation MAC CE command could be associated to/with a eleventh indicator indicating whether one or more TCI states or TCI state IDs in part 2 of the TCI codepoint associated with/to the eleventh indicator is present or not, wherein the eleventh indicator(s) could also be indicated/provided in the (same) third (unified) TCI state(s) activation/deactivation MAC CE command as specified herein in the present disclosure. For this case/example, when/if a TCI state or TCI state ID belongs to part 2 of a TCI codepoint corresponding to Case H, Case I, Case J, Case K, Case L, Case M, Case N, Case O, Case P, Case Q, Case R and/or Case S according to those specified herein in the present disclosure, one entry of the eleventh indicator (e.g., Qij) associated with/to part 2 of the TCI codepoint (e.g., part 2 of the i-th TCI codepoint) could indicate whether the TCI state or TCI state ID associated with/to the entry (e.g., the j-th TCI state or TCI state ID in part 2 of the i-th TCI codepoint) could be present or not. For this case, when/if the 1^{st} entry of a eleventh indicator (e.g., Qi1) is set to ‘1’ (or ‘0’), the first Type-II UL TCI state as in Case H to Case S (e.g., the 1^{st} TCI state or TCI state ID in part 2 of the i-th TCI codepoint) associated to/with the 1^{st} entry of the eleventh indicator (e.g., Qi1) could be present in the octet (i.e., in part 2 of the TCI codepoint—e.g., in part 2 of the i-th TCI codepoint); when/if the 1^{st} entry of a eleventh indicator (e.g., Qi1) is set to ‘0’ (or ‘1’), the first Type-II UL TCI state as in Case H to Case S (e.g., the 1^{st} TCI state or TCI state ID in part 2 of the i-th TCI codepoint) associated to/with the 1^{st} entry of the eleventh indicator (e.g., Qi1) could be absent in the octet (i.e., in part 2 of the TCI codepoint—e.g., in part 2 the i-th TCI codepoint). Furthermore, when/if the 2^{nd} entry of a eleventh indicator (e.g., Qi2) is set to ‘1’ (or ‘0’), the second Type-II UL TCI state as in Case H to Case S (e.g., the 2^{nd} TCI state or TCI state ID in part 2 of the i-th TCI codepoint) associated to/with the 2^{nd} entry of the eleventh indicator (e.g., Qi2) could be present in the octet (i.e., in part 2 of the TCI codepoint—e.g., in part 2 of the i-th TCI codepoint); when/if the 2^{nd} entry of a eleventh indicator (e.g., Qi2) is set to ‘0’ (or ‘1’), the second Type-II UL TCI state as in Case H to Case S (e.g., the 2^{nd} TCI state or TCI state ID in part 2 of the i-th TCI codepoint) associated to/with the 2^{nd} entry of the eleventh indicator (e.g., Qi2) could be absent in the octet (i.e., in part 2 of the TCI codepoint—e.g., in part 2 of the i-th TCI codepoint). For this design example, each of the TCI codepoint(s) of Case H, Case I, Case J, Case K, Case L, Case M, Case N, Case O, Case P, Case Q, Case R and/or Case S according to those specified herein in the present disclosure from or activated/indicated by/in the third (unified) TCI state(s) activation/deactivation MAC CE command could be associated to/with a bitmap with a eleventh one-bit indicator as specified herein in the present disclosure associated with/to part 2 of a TCI codepoint as an entry/bit position (e.g., the 9^{th} entry/bit position) of the bitmap associated to/with the corresponding TCI codepoint, wherein the bitmap(s) could also be indicated/provided in the (same) third (unified) TCI state(s) activation/deactivation MAC CE command as specified herein in the present disclosure.

In one embodiment, when/if the single-TRP and UL-only multi-TRP operation(s) is enabled according to those specified herein in the present disclosure, and/or when/if a UE (e.g., the UE 116) is provided/configured with dl-OrJointTCI-StateList and/or ul-TCI-StateList, the UE could use/apply a joint TCI state for both DL and UL channels/signals (including at least UE-dedicated reception(s) of PDCCH and PDSCH, and/or transmission(s) of dynamic-grant/configured-grant based PUSCH and on dedicated PUCCH resources), and/or a DL TCI state for DL channels/signals (including at least UE-dedicated reception(s) of PDCCH and PDSCH), and/or a first UL TCI state for UL channels/signals (including at least transmission(s) of dynamic-grant/configured-grant based PUSCH and on dedicated PUCCH resources). Furthermore, the UE may not expect that a first UL TCI state is indicated/provided in a/the pair of another UL TCI state indicated/provided in a/same TCI codepoint.
The joint TCI state for both DL and UL channels/signals here could correspond to a Type-I joint TCI state as specified herein in the present disclosure. That is, when/if a UE is indicated/provided by the network, e.g., via beam activation/indication MAC CE and/or DCI (e.g., DCI format 1_1/1_2), a Type-I joint TCI state according to those specified herein in the present disclosure, the UE could use/apply the Type-I joint TCI state to update or replace the joint TCI state that is being used/applied for both DL and UL channels/signals (including at least UE-dedicated reception(s) of PDCCH and PDSCH, and/or transmission(s) of dynamic-grant/configured-grant based PUSCH and on dedicated PUCCH resources).
The DL TCI state for DL channels/signals here could correspond to a Type-I DL TCI state as specified herein in the present disclosure. That is, when/if a UE is indicated/provided by the network, e.g., via beam activation/indication MAC CE and/or DCI (e.g., DCI format 1_1/1_2), a Type-I DL TCI state according to those specified herein in the present disclosure, the UE could use/apply the Type-I DL TCI state to update or replace the DL TCI state that is being used/applied for DL channels/signals (including at least UE-dedicated reception(s) of PDCCH and PDSCH).
The first UL TCI state for UL channels/signals here could correspond to a Type-I UL TCI state as specified herein in the present disclosure. That is, when/if a UE is indicated/provided by the network, e.g., via beam activation/indication MAC CE and/or DCI (e.g., DCI format 1_1/1_2), a Type-I UL TCI state according to those specified herein in the present disclosure, the UE could use/apply the Type-I UL TCI state to update or replace the first UL TCI state that is being used/applied for UL channels/signals (including at least transmission(s) of dynamic-grant/configured-grant based PUSCH and on dedicated PUCCH resources).

For this case, e.g., when/if the single-TRP and UL-only multi-TRP operation(s) is enabled according to those specified herein in the present disclosure, at least one of:
the UE may not expect or may not be expected to receive two PDCCH candidates in two CORESETs/search space sets configured with a higher layer parameter searchSpaceLinking.
the UE may not expect or may not be expected to be configured by higher layer parameter repetitionScheme set to one of ‘fdmSchemeA’, ‘fdmSchemeB’ and/or ‘tdmSchemeA’.
the UE may not expect or may not be expected to be configured by higher layer parameter repetitionNumber in PDSCH-TimeDomainResourceAllocation.
the UE may not expect or may not be expected to be configured with higher layer parameter sfnSchemePdcch set to either ‘sfnSchemeA’ or ‘sfnSchemeB’.
the UE may not expect or may not be expected to be configured with higher layer parameter sfnSchemePdsch set to either ‘sfnSchemeA’ or ‘sfnSchemeB’.
the UE may not expect or may not be expected to be configured or provided with higher layer parameter applyIndicatedTCIState in ControlResourceSet set to ‘first’, ‘second’, ‘both’ or ‘none’.
the UE may not expect a “TCI selection” field to be present in the corresponding DCI format(s), e.g., 1_1 and/or 1_2; i.e., the UE may not expect or may not be expected to be configured or provided with higher layer parameter tciSelectionPresentInDCI.
the UE may not expect or may not be expected to apply/use the first UL TCI state (or the Type-I UL TCI state) as specified herein in the present disclosure to when higher layer parameter applyIndicatedTCIState (set to ‘first’, ‘second’ or ‘both’) is configured/provided in PUCCH-Config/PUCCH-Resource for transmission(s) of PUCCH resource(s).
the UE may not expect or may not be expected to apply/use the first UL TCI state (or the Type-I UL TCI state) as specified herein in the present disclosure to when a SRS resource set indicator (set to ‘00’, ‘01’, ‘10’ or ‘11’) in the corresponding DCI format(s), e.g., 0_1 and/or 0_2, is used/applied for transmission(s) of PUSCH(s), wherein two SRS resource sets could be configured in srs-ResourceSetToAddModList or srs-ResourceSetToAddModListDCI-0-2 with higher layer parameter usage in SRS-ResourceSet set to ‘codebook’ or ‘noncodebook’.
the UE may not expect or may not be expected to apply/use the first UL TCI state (or the Type-I UL TCI state) as specified herein in the present disclosure to when higher layer parameter multipanelScheme (set to ‘SDMscheme’ or ‘SFNscheme’) is used/applied for transmission(s) of UL channels/signals.
the UE may not expect or may not be expected to apply/use the first UL TCI state (or the Type-I UL TCI state) as specified herein in the present disclosure to when higher layer parameter enable STx2PofmDCI is configured and used/applied for transmission(s) of UL channels/signals.
the UE may not expect or may not be expected to apply/use the first UL TCI state (or the Type-I UL TCI state) as specified herein in the present disclosure to PUCCH repetition(s), e.g., when the UE is indicated to transmit a PUCCH over N_{PUCCH}^{repeat} slots using a PUCCH resource wherein N_{PUCCH}^{repeat} could be provided by higher layer parameter(s) pucch-RepetitionNrofSlots or nrofSlots.

In one embodiment, when/if the single-TRP and UL-only multi-TRP operation(s) is enabled according to those specified herein in the present disclosure, and/or when/if a UE is provided/configured with dl-OrJointTCI-StateList and/or ul-TCI-StateList, the UE could use, apply or have two indicated UL TCI states-denoted by a second indicated UL TCI state and a third indicated UL TCI state—applicable for transmission(s) of various UL channels/signals (including at least transmission(s) of dynamic-grant/configured-grant based PUSCH and on dedicated PUCCH resources).
The second indicated UL TCI state could correspond to a first Type-II UL TCI state as specified herein in the present disclosure, and the third indicated UL TCI state could correspond to a second Type-II UL TCI state as specified herein in the present disclosure. For PUCCH transmission(s),
   when/if higher layer parameter applyIndicatedTCIState (e.g., if provided in PUCCH-Config/PUCCH-Resource) is set to ‘first’, the UE could transmit a PUCCH using a spatial domain filter corresponding to the second indicated UL TCI state; for this case, when/if a UE is indicated/provided by the network, e.g., via beam activation/indication MAC CE and/or DCI (e.g., DCI format 1_1/1_2), a first Type-II UL TCI state according to those specified herein in the present disclosure, the UE could use/apply the first Type-II UL TCI state to update or replace the second indicated UL TCI state to determine the spatial domain filter for transmitting the PUCCH;
   when/if higher layer parameter applyIndicatedTCIState (e.g., if provided in PUCCH-Config/PUCCH-Resource) is set to ‘second’, the UE could transmit a PUCCH using a spatial domain filter corresponding to the third indicated UL TCI state; for this case, when/if a UE is indicated/provided by the network, e.g., via beam activation/indication MAC CE and/or DCI (e.g., DCI format 1_1/1_2), a second Type-II UL TCI state according to those specified herein in the present disclosure, the UE could use/apply the second Type-II UL TCI state to update or replace the third indicated UL TCI state to determine the spatial domain filter for transmitting the PUCCH;
   when/if higher layer parameter applyIndicatedTCIState (e.g., if provided in PUCCH-Config/PUCCH-Resource) is set to ‘both’, the UE could transmit a PUCCH using respective first and second spatial domain filters corresponding to the second and third indicated UL TCI states; for this case, when/if the UE is indicated/provided by the network, e.g., via beam activation/indication MAC CE and/or DCI (e.g., DCI format 1_1/1_2), a first Type-II UL TCI state according to those specified herein in the present disclosure, the UE could use/apply the first Type-II UL TCI state to update or replace the second indicated UL TCI state to determine the first spatial domain filter for transmitting the PUCCH, and/or when/if the UE is indicated/provided by the network, e.g., via beam activation/indication MAC CE and/or DCI (e.g., DCI format 1_1/1_2), a second Type-II UL TCI state according to those specified herein in the present disclosure, the UE could use/apply the second Type-II UL TCI state to update or replace the third indicated UL TCI state to determine the second spatial domain filter for transmitting the PUCCH.
The second indicated UL TCI state could correspond to a first Type-II UL TCI state as specified herein in the present disclosure, and the third indicated UL TCI state could correspond to a second Type-II UL TCI state as specified herein in the present disclosure. For PUSCH transmission(s)—e.g., for PUSCH repetition Type A or Type B, or for PUSCH transmission(s) when the higher layer parameter multipanelScheme is set to ‘SDMscheme’ or ‘SFNscheme’, when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’:
   when/if a DCI format 0_1 or DCI format 0_2 indicates codepoint “00” for the SRS resource set indicator, the second indicated UL TCI state as specified herein in the present disclosure could be applied to PUSCH transmission occasions; for this case, when/if a UE is indicated/provided by the network (e.g., the network 130), e.g., via beam activation/indication MAC CE and/or DCI (e.g., DCI format 1_1/1_2), a first Type-II UL TCI state according to those specified herein in the present disclosure, the UE could use/apply the first Type-II UL TCI state to update or replace the second indicated UL TCI state to PUSCH transmission occasions;
   when/if a DCI format 0_1 or DCI format 0_2 indicates codepoint “01” for the SRS resource set indicator, the third indicated UL TCI state as specified herein in the present disclosure could be applied to PUSCH transmission occasions; for this case, when/if a UE is indicated/provided by the network, e.g., via beam activation/indication MAC CE and/or DCI (e.g., DCI format 1_1/1_2), a second Type-II UL TCI state according to those specified herein in the present disclosure, the UE could use/apply the second Type-II UL TCI state to update or replace the third indicated UL TCI state to PUSCH transmission occasions;
   when/if a DCI format 0_1 or DCI format 0_2 indicates codepoint “10” or “11”, for the SRS resource set indicator, and the multipanelScheme is not configured, the second indicated UL TCI state as specified herein in the present disclosure could be applied to the PUSCH transmission occasion(s) associated with the first SRS resource set and the third indicated UL TCI state as specified herein in the present disclosure could be applied to the PUSCH transmission occasion(s) associated with the second SRS resource set, where the association of PUSCH transmission occasions to SRS resource sets is determined for K=2 and K>2, and depending on whether cyclicMapping or sequentialMapping in PUSCH-Config is enabled; for this case, when/if the UE is indicated/provided by the network, e.g., via beam activation/indication MAC CE and/or DCI (e.g., DCI format 1_1/1_2), a first Type-II UL TCI state according to those specified herein in the present disclosure, the UE could use/apply the first Type-II UL TCI state to update or replace the second indicated UL TCI state to the PUSCH transmission occasion(s) associated with the first SRS resource set, and/or when/if the UE is indicated/provided by the network, e.g., via beam activation/indication MAC CE and/or DCI (e.g., DCI format 1_1/1_2), a second Type-II UL TCI state according to those specified herein in the present disclosure, the UE could use/apply the second Type-II UL TCI state to update or replace the third indicated UL TCI state to the PUSCH transmission occasion(s) associated with the second SRS resource set;
   when/if a DCI format 0_1 or DCI format 0_2 indicates codepoint “10” or “11”, for the SRS resource set indicator, and the higher layer parameter multipanelScheme is configured and set to ‘SDMscheme’ or ‘SFNscheme’, the second indicated UL TCI state as specified herein in the present disclosure could be applied to the PUSCH antenna ports of the corresponding PUSCH transmission occasion(s) associated with the first SRS resource set and the third indicated UL TCI state as specified herein in the present disclosure could be applied to the PUSCH antenna ports of the corresponding PUSCH transmission occasion(s) associated with the second SRS resource set, where the association of PUSCH transmission antenna ports to SRS resource sets is determined according to those specified herein in the present disclosure; for this case, when/if the UE is indicated/provided by the network, e.g., via beam activation/indication MAC CE and/or DCI (e.g., DCI format 1_1/1_2), a first Type-II UL TCI state according to those specified herein in the present disclosure, the UE could use/apply the first Type-II UL TCI state to update or replace the second indicated UL TCI state to the PUSCH antenna ports of the corresponding PUSCH transmission occasion(s) associated with the first SRS resource set, and/or when/if the UE is indicated/provided by the network, e.g., via beam activation/indication MAC CE and/or DCI (e.g., DCI format 1_1/1_2), a second Type-II UL TCI state according to those specified herein in the present disclosure, the UE could use/apply the second Type-II UL TCI state to update or replace the third indicated UL TCI state to the PUSCH antenna ports of the corresponding PUSCH transmission occasion(s) associated with the second SRS resource set.

For this case, e.g., when/if the single-TRP and UL-only multi-TRP operation(s) is enabled according to those specified herein in the present disclosure, at least one of:
the UE could expect or could be expected to apply/use the second (indicated) UL TCI state (or the first Type-II UL TCI state) and/or the third (indicated) UL TCI state (or the second Type-II UL TCI state) as specified herein in the present disclosure to when higher layer parameter applyIndicatedTCIState (set to ‘first’, ‘second’ or ‘both’) is configured/provided in PUCCH-Config/PUCCH-Resource for transmission(s) of PUCCH resource(s).
the UE could expect or could be expected to apply/use the second (indicated) UL TCI state (or the first Type-II UL TCI state) and/or the third (indicated) UL TCI state (or the second Type-II UL TCI state) as specified herein in the present disclosure to when a SRS resource set indicator (set to ‘00’, ‘01’, ‘10’ or ‘11’) in the corresponding DCI format(s), e.g., 0_1 and/or 0_2, is used/applied for transmission(s) of PUSCH(s), wherein two SRS resource sets could be configured in srs-ResourceSetToAddModList or srs-ResourceSetToAddModListDCI-0-2 with higher layer parameter usage in SRS-ResourceSet set to ‘codebook’ or ‘noncodebook’.
the UE could expect or could be expected to apply/use the second (indicated) UL TCI state (or the first Type-II UL TCI state) and/or the third (indicated) UL TCI state (or the second Type-II UL TCI state) as specified herein in the present disclosure to when higher layer parameter multipanelScheme (set to ‘SDMscheme’ or ‘SFNscheme’) is used/applied for transmission(s) of UL channels/signals.
the UE could expect or could be expected to apply/use the second (indicated) UL TCI state (or the first Type-II UL TCI state) and/or the third (indicated) UL TCI state (or the second Type-II UL TCI state) as specified herein in the present disclosure to when higher layer parameter enableSTx2PofmDCI is configured and used/applied for transmission(s) of UL channels/signals.
the UE could expect or could be expected to apply/use the second (indicated) UL TCI state (or the first Type-II UL TCI state) and/or the third (indicated) UL TCI state (or the second Type-II UL TCI state) as specified herein in the present disclosure to PUCCH repetition(s), e.g., when the UE is indicated to transmit a PUCCH over N_{PUCCH}^{repeat} slots using a PUCCH resource wherein N_{PUCCH}^{repeat} could be provided by higher layer parameter(s) pucch-RepetitionNrofSlots or nrofSlots.

Throughout the present disclosure, in addition to the condition(s) specified herein in the present disclosure, the single-TRP and UL-only multi-TRP operation(s) as specified herein in the present disclosure is enabled when/if one or more of the following conditions are achieved or satisfied or held:
The UE receives from the network a first (unified) TCI state(s) activation/deactivation MAC CE command as specified herein in the present disclosure used to map up to a certain number of TCI codepoints of a TCI field in a beam indication DCI, wherein each TCI codepoint could comprise or provide or correspond to or could be mapped to one or more Type-I joint/DL/UL TCI states for various single-TRP DL and/or UL channels according to those specified herein in the present disclosure.
The UE receives from the network a second (unified) TCI state(s) activation/deactivation MAC CE command as specified herein in the present disclosure used to map up to a certain number of TCI codepoints of a TCI field in a beam indication DCI, wherein each TCI codepoint could comprise or provide or correspond to or could be mapped to a first Type-II UL TCI state and/or a second Type-II UL TCI state for only multi-TRP UL channels/signals according to those specified herein in the present disclosure.
The UE receives from the network a third (unified) TCI state(s) activation/deactivation MAC CE command as specified herein in the present disclosure used to map up to a certain number of TCI codepoints of a TCI field in a beam indication DCI, wherein each TCI codepoint could comprise or provide or correspond to or could be mapped to one or more Type-I joint/DL/UL TCI states for various single-TRP DL and/or UL channels/signals according to those specified herein in the present disclosure, and/or a first Type-II UL TCI state and/or a second Type-II UL TCI state for only multi-TRP UL channels/signals according to those specified herein in the present disclosure.

In a multi-DCI based system, a UE could be provided or configured by higher layer parameter PDCCH-Config that contains two different values (e.g., 0 and 1) of coresetPoolIndex in ControlResourceSet.
In one example, for a serving cell, the UE could be provided two coresetPoolIndex values 0 and 1 for first and second CORESETs, or
In another example, for a serving cell, the UE is not provided coresetPoolIndex value for first CORESETs and is provided coresetPoolIndex value of 1 for second CORESETs.

Furthermore, in a multi-DCI based system according to those specified herein in the present disclosure, and when/if the single-TRP and UL-only multi-TRP operation(s) is enabled according to those specified herein in the present disclosure, the UE could expect that DL channels/signals including at least PDCCH(s) and PDSCH(s) are not associated/configured to/with different values of coresetPoolIndex (e.g., 0 and/or 1) or the UE could expect that DL channels/signals including at least PDCCH(s) and PDSCH(s) are associated/configured to/with a/the single (same) value of coresetPoolIndex (i.e., 0 or 1); i.e., the UE could expect that different values of coresetPoolIndex (e.g., 0 and/or 1) are not applicable to DL channels/signals including at least PDCCH(s) and PDSCH(s) or the UE could expect that a/the single (same) value of coresetPoolIndex (i.e., 0 or 1) is applicable to DL channels/signals including at least PDCCH(s) and PDSCH(s). In addition, for this case, the UE could expect that only UL channels/signals including at least PUCCH(s) and PUSCH(s) are associated/configured to/with different values of coresetPoolIndex (e.g., 0 and/or 1); i.e., the UE could expect that different values of coresetPoolIndex (e.g., 0 and/or 1) are only applicable to UL channels/signals including at least PUCCH(s) and PUSCH(s).

In one embodiment, in a multi-DCI based system according to those specified herein in the present disclosure, and when/if the single-TRP and UL-only multi-TRP operation(s) is enabled according to those specified herein in the present disclosure, a UE could receive from the network a fourth (unified) TCI state(s) activation/deactivation MAC CE command associated/configured with a value (e.g., 0 and/or 1) of coresetPoolIndex (e.g., the value of coresetPoolIndex could be provided/indicated in the fourth (unified) TCI state(s) activation/deactivation MAC CE command via/as a new/dedicated field or by repurposing a reserved ‘R’ field), used to map up to Nul, e.g., 8, TCI states for UL channels/signals—e.g., each provided by TCI-UL-State, to the codepoints of the DCI field ‘Transmission Configuration Indication’ in a beam indication DCI (e.g., UL DCI format 0_0, 0_1, or 0_2 with or without UL grant, and/or DL DCI format 1_0, 1_1 or 1_2 with or without DL assignment)—e.g., the beam indication DCI could be associated to/with the same value of coresetPoolIndex—for one or for a set of CCs/UL BWPs. When a set of TCI state IDs are activated for a set of CCs/UL BWPs, where the applicable list of CCs is determined by the indicated CC in the activation command, the same set of TCI state IDs are applied for UL BWPs in the indicated CCs. If the fourth MAC CE activation command maps TCI-UL-State(s) to only one TCI codepoint, the UE shall apply the indicated TCI-UL-State(s) to one or to a set of CCs/UL BWPs once the indicated mapping for the one single TCI codepoint is applied. The beam indication DCI as described/specified herein in the present disclosure could be associated to/with a value of coresetPoolIndex according to one of:
In one example, the DCI format(s) corresponding to the beam indication DCI could have a one-bit DCI indicator. For this design example, when/if the one-bit DCI indicator is set to ‘0’ (or ‘1’), the beam indication DCI could be associated to/with value 0 of coresetPoolIndex, and when/if the one-bit DCI indicator is set to ‘1’ (or ‘0’), the beam indication DCI could be associated to/with value 1 of coresetPoolIndex. The one-bit DCI indicator could be a new/dedicated DCI field introduced in the corresponding DCI format(s); optionally, the one-bit DCI indicator could be implemented in the corresponding DCI format(s) via/by repurposing one or more bits of one or more existing DCI fields in the corresponding DCI format(s). A UE could be configured/provided/indicated by the network, e.g., via/by higher layer RRC signaling(s)/parameter(s) and/or MAC CE command(s) and/or dynamic DCI based L1 signaling(s), whether or not the one-bit DCI indicator as specified herein in the present disclosure is present (or absent) in the corresponding DCI format(s).
In another example, the DCI format(s) corresponding to the beam indication DCI could have a DCI field indicating a value of coresetPoolIndex. For this design example, when/if the DCI field has value 0 of coresetPoolIndex, the beam indication DCI could be associated to/with value 0 of coresetPoolIndex, and when/if the DCI field has value 1 of coresetPoolIndex, the beam indication DCI could be associated to/with value 1 of coresetPoolIndex. The DCI field as described herein could be a new/dedicated DCI field introduced in the corresponding DCI format(s); optionally, the DCI field as described here could be implemented in the corresponding DCI format(s) via/by repurposing one or more bits of one or more existing DCI fields in the corresponding DCI format(s). A UE could be configured/provided/indicated by the network, e.g., via/by higher layer RRC signaling(s)/parameter(s) and/or MAC CE command(s) and/or dynamic DCI based L1 signaling(s), whether or not the DCI as specified/described herein in the present disclosure is present (or absent) in the corresponding DCI format(s).
In another example, the DCI format(s) corresponding to the beam indication DCI could have a bitmap (e.g., of length two) DCI indicator. For this design example, when/if the first entry or bit position of the bitmap DCI indicator is set to ‘0’ (or ‘1’), the beam indication DCI could be associated to/with value 0 of coresetPoolIndex, and when/if the second entry or bit position of the bitmap DCI indicator is set to ‘1’ (or ‘0’), the beam indication DCI could be associated to/with value 1 of coresetPoolIndex. The bitmap DCI indicator could be a new/dedicated DCI field introduced in the corresponding DCI format(s); optionally, the bitmap DCI indicator could be implemented in the corresponding DCI format(s) via/by repurposing one or more bits of one or more existing DCI fields in the corresponding DCI format(s). A UE could be configured/provided/indicated by the network, e.g., via/by higher layer RRC signaling(s)/parameter(s) and/or MAC CE command(s) and/or dynamic DCI based L1 signaling(s), whether or not the bitmap DCI indicator as specified herein in the present disclosure is present (or absent) in the corresponding DCI format(s).
In another example, when/if the beam indication DCI is received in CORESET(s) configured/associated with value 0 of coresetPoolIndex (e.g., the first CORESET(s) as specified herein in the present disclosure), the beam indication DCI could be associated to/with value 0 of coresetPoolIndex, and when/if the beam indication DCI is received in CORESET(s) configured/associated with value 1 of coresetPoolIndex (e.g., the second CORESET(s) as specified herein in the present disclosure), the beam indication DCI could be associated to/with value 1 of coresetPoolIndex.
In another example, a UE could be provided or configured by higher layer parameter PDCCH-Config that contains two different values (e.g., 0 and 1) of coresetGroupIndex in ControlResourceSet. For instance, for a serving cell, the UE could be provided two coresetGroupIndex values 0 and 1 for third and fourth CORESETs, or for a serving cell, the UE is not provided coresetGroupIndex value for third CORESETs and is provided coresetGroupIndex value of 1 for fourth CORESETs. For this case/design example, when/if the beam indication DCI is received in CORESET(s) configured/associated with value 0 of coresetGroupIndex (e.g., the third CORESET(s) as specified herein in the present disclosure), the beam indication DCI could be associated to/with value 0 of coresetPoolIndex, and when/if the beam indication DCI is received in CORESET(s) configured/associated with value 1 of coresetGroupIndex (e.g., the fourth CORESET(s) as specified herein in the present disclosure), the beam indication DCI could be associated to/with value 1 of coresetPoolIndex.

Optionally,
In one example, the DCI format(s) corresponding to the beam indication DCI could have two ‘Transmission Configuration Indication’ TCI fields-referred to as or denoted by a first TCI field and a second TCI field. For this case/design example, the first TCI field could be used/applied to indicate TCI codepoint(s) activated from/in the third (unified) TCI state(s) activation/deactivation MAC CE command associated with/to value 0 (or 1) of coresetPoolIndex according to those specified herein in the present disclosure, and the second TCI field could be used/applied to indicate TCI codepoint(s) activated from/in the third (unified) TCI state(s) activation/deactivation MAC CE command associated with/to value 1 (or 0) of coresetPoolIndex according to those specified herein in the present disclosure.
In another example, the DCI format(s) corresponding to the beam indication DCI could have a ‘Transmission Configuration Indication’ TCI field to indicate TCI codepoint(s) activated from/in the third (unified) TCI state(s) activation/deactivation MAC CE commands. For this case/design example, the TCI field could be used/applied to indicate TCI codepoint(s) activated from/in the third (unified) TCI state(s) activation/deactivation MAC CE commands respectively associated with/to values 0 and 1 of coresetPoolIndex according to those specified herein in the present disclosure. For instance, the UE (e.g., the UE 116) could be first indicated/provided by the network, a TCI codepoint index, of the TCI field in the beam indication DCI (i.e., in the corresponding DCI format(s)); for this case/design example,
   the UE could determine/identify, according to or based on the indicated TCI codepoint index, a TCI codepoint comprising one or more TCI states from a third (unified) TCI state(s) activation/deactivation MAC CE command associated with/to value 0 of coresetPoolIndex, and use/apply the determined/identified one or more TCI states to determine spatial domain filter(s) for transmitting various UL channels/signals including at least PUCCH(s) and PUSCH(s) associated/configured with/to value 0 of coresetPoolIndex.
   the UE could determine/identify, according to or based on the indicated TCI codepoint index, a TCI codepoint comprising one or more TCI states from a third (unified) TCI state(s) activation/deactivation MAC CE command associated with/to value 1 of coresetPoolIndex, and use/apply the determined/identified one or more TCI states to determine spatial domain filter(s) for transmitting various UL channels/signals including at least PUCCH(s) and PUSCH(s) associated/configured with/to value 1 of coresetPoolIndex.

In one embodiment, in a multi-DCI based system according to those specified herein in the present disclosure, and when/if the single-TRP and UL-only multi-TRP operation(s) is enabled according to those specified herein in the present disclosure, the UE could receive from the network a second (unified) TCI state(s) activation/deactivation MAC CE command or a third (unified) TCI state(s) activation/deactivation MAC CE command according to those specified herein in the present disclosure. For this case, the first Type-II UL TCI state(s) activated in/from the second/third (unified) TCI state(s) activation/deactivation MAC CE command(s) could be associated with/to value 0 (or 1) of coresetPoolIndex—i.e., when/if a first Type-II UL TCI state is indicated by a TCI codepoint of a TCI field in a beam indication DCI, the UE could use/apply the indicated first Type-II UL TCI state to determine spatial domain filter(s) for transmitting various UL channels/signals including at least PUCCH(s) and PUSCH(s) associated/configured with/to value 0 (or 1) of coresetPoolIndex. And/or, the second Type-II UL TCI state(s) activated in/from the second/third (unified) TCI state(s) activation/deactivation MAC CE command(s) could be associated with/to value 1 (or 0) of coresetPoolIndex—i.e., when/if a second Type-II UL TCI state is indicated by a TCI codepoint of a TCI field in a beam indication DCI, the UE could use/apply the indicated second Type-II UL TCI state to determine spatial domain filter(s) for transmitting various UL channels/signals including at least PUCCH(s) and PUSCH(s) associated/configured with/to value 1 (or 0) of coresetPoolIndex.

Moreover, in a multi-DCI based system according to those specified herein in the present disclosure, and when/if the single-TRP and UL-only multi-TRP operation(s) is enabled according to those specified herein in the present disclosure, a UE could receive from the network a first (unified) TCI state(s) activation/deactivation MAC CE command as specified herein in the present disclosure for the single-TRP operation, wherein the first (unified) TCI state(s) activation/deactivation MAC CE command is not associated/configured with any value(s) of coresetPoolIndex, or is associated/configured with a single (same) value of coresetPoolIndex (e.g., value 0). In addition, the described/specified design procedure/examples herein could be applied or extended to when the UE is provided/configured with higher layer parameter AdditionalPCIInfo—i.e., when inter-cell multi-TRP operation is enabled, wherein the (first) CORESET(s) associated/configured with a value (e.g., 0) of coresetPoolIndex and/or TCI state(s) activated/indicated for the (first) CORESET(s) associated/configured with a value (e.g., 0) of coresetPoolIndex could be associated with the serving cell PCI, and the (second) CORESET(s) associated/configured with another or a different value (e.g., 1) of coresetPoolIndex and/or TCI state(s) activated/indicated for the (second) CORESET(s) associated/configured with another or a different value (e.g., 1) of coresetPoolIndex could be associated with a PCI other than the serving cell PCI.

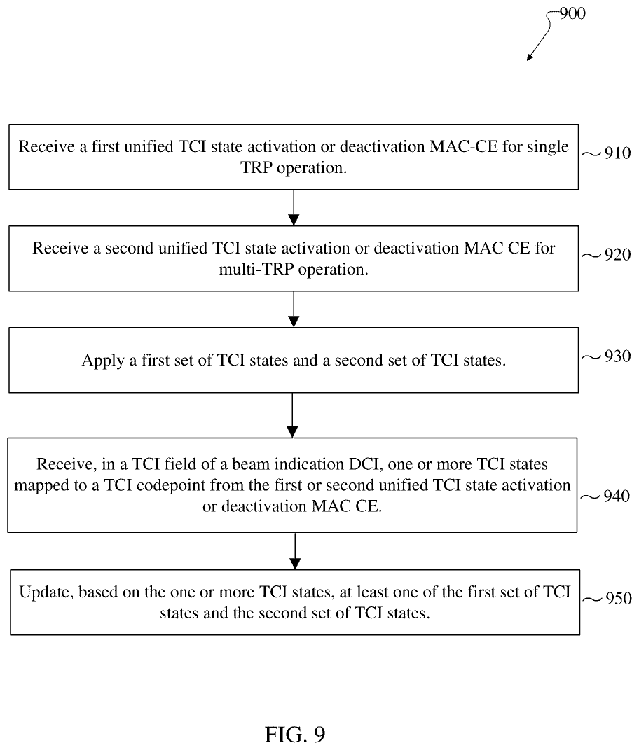

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving a first unified TCI state activation or deactivation MAC-CE for single TRP operation (910). The UE then receives a second unified TCI state activation or deactivation MAC CE for multi-TRP operation (920). For example, in 910 and 920, the received unified TCI state activation or deactivation MAC CEs are received in the same BWP or serving cell. The UE then applies a first set of TCI states and a second set of TCI states (930). For example, in 930, the applied TCI states are those being used by the UE prior to the after mentioned update.

The UE then receives, in a TCI field of a beam indication DCI, one or more TCI states mapped to a TCI codepoint from the first or second unified TCI state activation or deactivation MAC CE (940). In various embodiments, the TCI codepoint from the first unified TCI state activation or deactivation MAC CE is mapped to at least one of a DL TCI state and an UL TCI state. In various embodiments, the TCI codepoint from the second unified TCI state activation or deactivation MAC CE is mapped to at least one of a DL TCI state, a first UL TCI state, and a second UL TCI state.

In various embodiments, the UE identifies an indicator and determines, based on the indicator, whether the TCI codepoint is from the first or second unified TCI state activation or deactivation MAC CE. In various embodiments, the indicator is a one-bit field in the beam indication DCI. When the indicator is set to ‘1’, the TCI codepoint is from the first unified TCI state activation or deactivation MAC CE. When the indicator is set to ‘0’, the TCI codepoint is from the second unified TCI state activation or deactivation MAC CE.

The UE then updates, based on the one or more TCI states, at least one of the first set of TCI states and the second set of TCI states (950). In various embodiments, when the TCI codepoint is from the first unified TCI state activation or deactivation MAC CE, the UE updates the first and second sets of TCI states. In various embodiments, when the TCI codepoint is from the first unified TCI state activation or deactivation MAC CE, the UE updates the first set of TCI states and, when the TCI codepoint is from the second unified TCI state activation or deactivation MAC CE, the UE updates the first and second sets of TCI states.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, in a bandwidth part (BWP) or a serving cell, a first unified transmission configuration indication (TCI) state activation or deactivation medium access control (MAC) control element (CE) for single transmission and reception point (single-TRP) operation; and
receive, in the BWP or the serving cell, a second unified TCI state activation or deactivation MAC CE for multiple-TRP (multi-TRP) operation; and
a processor operably coupled with the transceiver, the processor configured to apply a first set of TCI states and a second set of TCI states,
wherein the transceiver is further configured to receive, in a TCI field of a beam indication downlink control information (DCI), one or more TCI states mapped to a TCI codepoint from the first or second unified TCI state activation or deactivation MAC CE, and
wherein the processor is further configured to update, based on the one or more TCI states, at least one of the first set of TCI states and the second set of TCI states.

2. The UE of claim 1, wherein the TCI codepoint from the first unified TCI state activation or deactivation MAC CE is mapped to at least one of:
a downlink (DL) TCI state; and
an uplink (UL) TCI state.

3. The UE of claim 1, wherein the TCI codepoint from the second unified TCI state activation or deactivation MAC CE is mapped to at least one of:
a downlink (DL) TCI state;
a first uplink (UL) TCI state; and
a second UL TCI state.

4. The UE of claim 1, wherein the processor is further configured to:
identify an indicator; and
determine, based on the indicator, whether the TCI codepoint is from the first or second unified TCI state activation or deactivation MAC CE.

5. The UE of claim 4, wherein:
the indicator is a one-bit field in the beam indication DCI;
when the indicator is set to ‘1’, the TCI codepoint is from the first unified TCI state activation or deactivation MAC CE; and
when the indicator is set to ‘0’, the TCI codepoint is from the second unified TCI state activation or deactivation MAC CE.

6. The UE of claim 1, wherein, when the TCI codepoint is from the first unified TCI state activation or deactivation MAC CE, the processor is further configured to update the first and second sets of TCI states.

7. The UE of claim 1, wherein the processor is further configured to:
when the TCI codepoint is from the first unified TCI state activation or deactivation MAC CE, update the first set of TCI states; and
when the TCI codepoint is from the second unified TCI state activation or deactivation MAC CE, update the first and second sets of TCI states.

8. A base station (BS), comprising:
a processor; and
a transceiver operably coupled with the processor, the transceiver configured to:
transmit, in a bandwidth part (BWP) or a serving cell, a first unified transmission configuration indication (TCI) state activation or deactivation medium access control (MAC) control element (CE) for single transmission and reception point (single-TRP) operation;
transmit, in the BWP or the serving cell, a second unified TCI state activation or deactivation MAC CE for multiple-TRP (multi-TRP) operation; and
transmit, in a TCI field of a beam indication downlink control information (DCI), one or more TCI states mapped to a TCI codepoint from the first or second unified TCI state activation or deactivation MAC CE, and
wherein at least one of a first set of TCI states and a second set of TCI states are updated based on the one or more TCI states.

9. The BS of claim 8, wherein the TCI codepoint from the first unified TCI state activation or deactivation MAC CE is mapped to at least one of:
a downlink (DL) TCI state; and
an uplink (UL) TCI state.

10. The BS of claim 8, wherein the TCI codepoint from the second unified TCI state activation or deactivation MAC CE is mapped to at least one of:
a downlink (DL) TCI state;
a first uplink (UL) TCI state; and
a second UL TCI state.

11. The BS of claim 8, wherein whether the TCI codepoint is from the first or second unified TCI state activation or deactivation MAC CE is indicated by an indicator.

12. The BS of claim 11, wherein:
the indicator is a one-bit field in the beam indication DCI;
when the indicator is set to ‘1’, the TCI codepoint is from the first unified TCI state activation or deactivation MAC CE; and
when the indicator is set to ‘0’, the TCI codepoint is from the second unified TCI state activation or deactivation MAC CE.

13. The BS of claim 8, wherein, when the TCI codepoint is from the first unified TCI state activation or deactivation MAC CE, the first and second sets of TCI states are updated.

14. The BS of claim 8, wherein:
when the TCI codepoint is from the first unified TCI state activation or deactivation MAC CE, the first set of TCI states is updated; and
when the TCI codepoint is from the second unified TCI state activation or deactivation MAC CE, the first and second sets of TCI states are updated.

15. A method performed by a user equipment (UE), the method comprising:
receiving, in a bandwidth part (BWP) or a serving cell, a first unified transmission configuration indication (TCI) state activation or deactivation medium access control (MAC) control element (CE) for single transmission and reception point (single-TRP) operation;
receiving, in the BWP or the serving cell, a second unified TCI state activation or deactivation MAC CE for multiple-TRP (multi-TRP) operation;
applying a first set of TCI states and a second set of TCI states;
receiving, in a TCI field of a beam indication downlink control information (DCI), one or more TCI states mapped to a TCI codepoint from the first or second unified TCI state activation or deactivation MAC CE; and
updating, based on the one or more TCI states, at least one of the first set of TCI states and the second set of TCI states.

16. The method of claim 15, wherein the TCI codepoint from the first unified TCI state activation or deactivation MAC CE is mapped to at least one of:
a downlink (DL) TCI state; and
an uplink (UL) TCI state.

17. The method of claim 15, wherein the TCI codepoint from the second unified TCI state activation or deactivation MAC CE is mapped to at least one of:
a downlink (DL) TCI state;
a first uplink (UL) TCI state; and
a second UL TCI state.

18. The method of claim 15, further comprising:
identifying an indicator; and
determining, based on the indicator, whether the TCI codepoint is from the first or second unified TCI state activation or deactivation MAC CE.

19. The method of claim 18, wherein:
the indicator is a one-bit field in the beam indication DCI;
when the indicator is set to ‘1’, the TCI codepoint is from the first unified TCI state activation or deactivation MAC CE; and
when the indicator is set to ‘0’, the TCI codepoint is from the second unified TCI state activation or deactivation MAC CE.

20. The method of claim 15, wherein updating at least one of the first set of TCI states and the second set of TCI states further comprises, when the TCI codepoint is from the first unified TCI state activation or deactivation MAC CE, updating the first and second sets of TCI states.
